(19) United States
(12) Patent Application Publication
(10) Pub. No.: US 2024/0381109 A1
(43) Pub. Date: Nov. 14, 2024

(54) MACHINE LEARNING MODELS FOR SPATIAL REUSE

(71) Applicant: QUALCOMM Incorporated, San Diego, CA (US)

(72) Inventors: Gaurang NAIK, San Diego, CA (US); George CHERIAN, San Diego, CA (US); Abhishek Pramod PATIL, San Diego, CA (US); Yanjun SUN, San Diego, CA (US); Abdel Karim AJAMI, San Diego, CA (US); Alfred ASTERJADHI, San Diego, CA (US); Sai Yiu Duncan HO, San Diego, CA (US)

(21) Appl. No.: 18/317,013

(22) Filed: May 12, 2023

(51) Int. Cl. H04W 16/14; H04L 41/16

(52) U.S. Cl. CPC H04W 16/14; H04L 41/16

(57) ABSTRACT

This disclosure provides methods, components, devices and systems for machine learning models for spatial reuse. Some aspects more specifically relate to machine learning (ML) models for spatial reuse (SR). In some aspects, an access point (AP) may transmit ML model information to a station (STA). The ML model information may include an indication of an ML model, one or more parameters defining the ML model, one or more inputs for the ML model, one or more outputs for the ML model, or any combination thereof. A transmitting device may generate one or more inputs for the ML model, which may be local measurements or observations, input values indicated by one or more other STAs, information provided by an AP, one or more inferences (such as a candidate SR parameter value, or candidate action), or a combination thereof.

### TECHNICAL FIELD

This disclosure relates to wireless communication and, more specifically, to machine learning models for spatial reuse (SR).

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, one or more wireless devices, such as wireless STAs and/or wireless APs, may support spatial reuse (SR) procedures. SR techniques allow some wireless devices to transmit packets via a wireless medium while a transmission opportunity (TXOP) owner is transmitting on the same wireless medium if a power level of the transmission by the TXOP owner is below a certain value (such as an overlapping basic service set (OBSS) preamble detection (PD) level). Determining which transmissions satisfy SR parameter values, or permitted transmit power by overlapping transmissions, may be effectively determined according to a machine learning (ML) model. Such a ML model may be ineffective without a mechanism by which to identify the ML model by transmitting devices, or an effective mechanism by which to identify inputs to the model that may not be accessible by the transmitting device.

### SUMMARY

The systems, methods, and devices of this disclosure each have several innovative aspects, no single one of which is solely responsible for the desirable attributes disclosed herein.

One innovative aspect of the of the subject matter described in this disclosure can be implemented in a method for wireless communications at a device. The method may include outputting a first message requesting a machine learning model corresponding to a spatial reuse procedure, obtaining, in accordance with outputting the first message, a second message indicating information corresponding to the machine learning model, the information including a model structure corresponding to the machine learning model, an identifier indicating the machine learning model, one or more inputs corresponding to the machine learning model, one or more outputs corresponding to the machine learning model, or any combination thereof, generating one or more spatial reuse parameter values corresponding to the one or more outputs according to the machine learning model and the one or more inputs, and outputting one or more frames according to the spatial reuse procedure in accordance with the one or more spatial reuse parameter values.

Another innovative aspect of the of the subject matter described in this disclosure can be implemented in an apparatus for wireless communications at a device. The apparatus may include at least one memory, and at least one processor communicatively coupled with the at least one memory, the at least one processor operable to cause the apparatus to output a first message requesting a machine learning model corresponding to a spatial reuse procedure, obtain, in accordance with outputting the first message, a second message indicating information corresponding to the machine learning model, the information including a model structure corresponding to the machine learning model, an identifier indicating the machine learning model, one or more inputs corresponding to the machine learning model, one or more outputs corresponding to the machine learning model, or any combination thereof, generate one or more spatial reuse parameter values corresponding to the one or more outputs according to the machine learning model and the one or more inputs, and output one or more frames according to the spatial reuse procedure in accordance with the one or more spatial reuse parameter values.

Another innovative aspect of the of the subject matter described in this disclosure can be implemented in another apparatus for wireless communications at a device. The apparatus may include means for outputting a first message requesting a machine learning model corresponding to a spatial reuse procedure, means for obtaining, in accordance with outputting the first message, a second message indicating information corresponding to the machine learning model, the information including a model structure corresponding to the machine learning model, an identifier indicating the machine learning model, one or more inputs corresponding to the machine learning model, one or more outputs corresponding to the machine learning model, or any combination thereof, means for generating one or more spatial reuse parameter values corresponding to the one or more outputs according to the machine learning model and the one or more inputs, and means for outputting one or more frames according to the spatial reuse procedure in accordance with the one or more spatial reuse parameter values.

Another innovative aspect of the of the subject matter described in this disclosure can be implemented in a non-transitory computer-readable medium storing code for wireless communications at a device. The code may include instructions executable by at least one processor to output a first message requesting a machine learning model corresponding to a spatial reuse procedure, obtain, in accordance with outputting the first message, a second message indicating information corresponding to the machine learning model, the information including a model structure corresponding to the machine learning model, an identifier indicating the machine learning model, one or more inputs corresponding to the machine learning model, one or more outputs corresponding to the machine learning model, or any combination thereof, generate one or more spatial reuse parameter values corresponding to the one or more outputs according to the machine learning model and the one or more inputs, and output one or more frames according to the spatial reuse procedure in accordance with the one or more spatial reuse parameter values.

Another innovative aspect of the of the subject matter described in this disclosure can be implemented in a method for wireless communications. The method may include obtaining, from a first device by a second device, a first message requesting a machine learning model corresponding to a spatial reuse procedure, outputting, in accordance with obtaining the first message, a second message indicating information corresponding to the machine learning model, the information including a model structure corresponding to the machine learning model, an identifier indicating the machine learning model, one or more inputs corresponding to the machine learning model, one or more outputs corresponding to the machine learning model, or any combination thereof, and obtaining one or more frames according to the spatial reuse procedure in accordance with one or more spatial reuse parameter values associated with the one or more outputs corresponding to the machine learning model.

Another innovative aspect of the of the subject matter described in this disclosure can be implemented in an apparatus for wireless communications. The apparatus may include at least one memory, and at least one processor communicatively coupled with the at least one memory, the at least one processor operable to cause the apparatus to obtain, from a first device by a second device, a first message requesting a machine learning model corresponding to a spatial reuse procedure, outputting, in accordance with obtain the first message, a second message indicating information corresponding to the machine learning model, the information including a model structure corresponding to the machine learning model, an identifier indicating the machine learning model, one or more inputs corresponding to the machine learning model, one or more outputs corresponding to the machine learning model, or any combination thereof, and obtain one or more frames according to the spatial reuse procedure in accordance with one or more spatial reuse parameter values associated with the one or more outputs corresponding to the machine learning model.

Another innovative aspect of the of the subject matter described in this disclosure can be implemented in another apparatus for wireless communications at. The apparatus may include means for obtaining, from a first device by a second device, a first message requesting a machine learning model corresponding to a spatial reuse procedure, means for outputting, in accordance with obtaining the first message, a second message indicating information corresponding to the machine learning model, the information including a model structure corresponding to the machine learning model, an identifier indicating the machine learning model, one or more inputs corresponding to the machine learning model, one or more outputs corresponding to the machine learning model, or any combination thereof, and means for obtaining one or more frames according to the spatial reuse procedure in accordance with one or more spatial reuse parameter values associated with the one or more outputs corresponding to the machine learning model.

Another innovative aspect of the of the subject matter described in this disclosure can be implemented in a non-transitory computer-readable medium storing code for wireless communications. The code may include instructions executable by at least one processor to obtain, from a first device by a second device, a first message requesting a machine learning model corresponding to a spatial reuse procedure, outputting, in accordance with obtain the first message, a second message indicating information corresponding to the machine learning model, the information including a model structure corresponding to the machine learning model, an identifier indicating the machine learning model, one or more inputs corresponding to the machine learning model, one or more outputs corresponding to the machine learning model, or any combination thereof, and obtain one or more frames according to the spatial reuse procedure in accordance with one or more spatial reuse parameter values associated with the one or more outputs corresponding to the machine learning model.

Some examples of the method, apparatuses, and non-transitory computer-readable medium described herein may further include operations, features, means, or instructions for outputting an indication of one or more values corresponding to the one or more inputs, the one or more values corresponding to one or more neighbor devices, where obtaining the one or more frames may be based on outputting the indication of the one or more values.

Some examples of the method, apparatuses, and non-transitory computer-readable medium described herein may further include operations, features, means, or instructions for obtaining reporting information from the one or more neighbor devices and generating the one or more values corresponding to the one or more inputs based on the reporting information.

Some examples of the method, apparatuses, and non-transitory computer-readable medium described herein may further include operations, features, means, or instructions for outputting an information request message to a third device indicating the one or more spatial reuse parameter values and obtaining, from the third device based on the information request message, an information response message including the one or more values corresponding to the one or more inputs.

Some examples of the method, apparatuses, and non-transitory computer-readable medium described herein may further include operations, features, means, or instructions for outputting a third message indicating an availability of the machine learning model corresponding to the spatial reuse procedure, where obtaining the request message may be based on outputting the third message.

Another innovative aspect of the of the subject matter described in this disclosure can be implemented in a method for wireless communications at a device. The method may include obtaining a first message including spatial reuse information corresponding to one or more inputs of a machine learning model associated with a spatial reuse procedure, inputting the one or more inputs into the machine learning model based on the spatial reuse information, generating one or more spatial reuse parameter values corresponding to one or more outputs according to the machine learning model and the one or more inputs, and outputting one or more frames according to the spatial reuse procedure in accordance with the one or more spatial reuse parameter values.

Another innovative aspect of the of the subject matter described in this. The apparatus may include at least one memory, and at least one processor communicatively coupled with the at least one memory, the at least one processor operable to cause the apparatus to obtain a first message including spatial reuse information corresponding to one or more inputs of a machine learning model associated with a spatial reuse procedure, input the one or more inputs into the machine learning model based on the spatial reuse information, generate one or more spatial reuse parameter values corresponding to one or more outputs according to the machine learning model and the one or more inputs, and output one or more frames according to the spatial reuse procedure in accordance with the one or more spatial reuse parameter values.

Another innovative aspect of the of the subject matter described in this disclosure can be implemented in another apparatus for wireless communications at a device. The apparatus may include means for obtaining a first message including spatial reuse information corresponding to one or more inputs of a machine learning model associated with a spatial reuse procedure, means for inputting the one or more inputs into the machine learning model based on the spatial reuse information, means for generating one or more spatial reuse parameter values corresponding to one or more outputs according to the machine learning model and the one or more inputs, and means for outputting one or more frames according to the spatial reuse procedure in accordance with the one or more spatial reuse parameter values.

Another innovative aspect of the of the subject matter described in this disclosure can be implemented in a non-transitory computer-readable medium storing code for wireless communications at a device. The code may include instructions executable by at least one processor to obtain a first message including spatial reuse information corresponding to one or more inputs of a machine learning model associated with a spatial reuse procedure, input the one or more inputs into the machine learning model based on the spatial reuse information, generate one or more spatial reuse parameter values corresponding to one or more outputs according to the machine learning model and the one or more inputs, and output one or more frames according to the spatial reuse procedure in accordance with the one or more spatial reuse parameter values.

Some examples of the method, apparatuses, and non-transitory computer-readable medium described herein may further include operations, features, means, or instructions for obtaining a spatial reuse information request message and outputting, based on obtaining the spatial reuse information request message, a spatial reuse information response message including one or more local observations, one or more local measurements, or a combination thereof, where obtaining the message including the spatial reuse information may be based on outputting the spatial reuse information response message.

Another innovative aspect of the of the subject matter described in this disclosure can be implemented in a method for wireless communications at a device. The method may include outputting a message including spatial reuse information corresponding to one or more inputs of a machine learning model associated with a spatial reuse procedure and obtaining, from a first station, one or more frames according to the spatial reuse procedure in accordance with one or more spatial reuse parameter values associated with the spatial reuse information.

Another innovative aspect of the of the subject matter described in this disclosure can be implemented in an apparatus for wireless communications at a device. The apparatus may include at least one memory, and at least one processor communicatively coupled with the at least one memory, the at least one processor operable to cause the apparatus to output a message including spatial reuse information corresponding to one or more inputs of a machine learning model associated with a spatial reuse procedure and obtain, from a first station, one or more frames according to the spatial reuse procedure in accordance with one or more spatial reuse parameter values associated with the spatial reuse information.

Another innovative aspect of the of the subject matter described in this disclosure can be implemented in an apparatus for wireless communications at a device. The apparatus may include means for outputting a message including spatial reuse information corresponding to one or more inputs of a machine learning model associated with a spatial reuse procedure and means for obtaining, from a first station, one or more frames according to the spatial reuse procedure in accordance with one or more spatial reuse parameter values associated with the spatial reuse information.

Another innovative aspect of the of the subject matter described in this disclosure can be implemented in a non-transitory computer-readable medium storing code for wireless communications at a device. The code may include instructions executable by at least one processor to output a message including spatial reuse information corresponding to one or more inputs of a machine learning model associated with a spatial reuse procedure and obtain, from a first station, one or more frames according to the spatial reuse procedure in accordance with one or more spatial reuse parameter values associated with the spatial reuse information.

Details of one or more aspect of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a pictorial diagram of another example wireless communication network that supports machine learning models for spatial reuse (SR) according to some aspects of the present disclosure.

FIG. 3 shows an example of a process flow that supports machine learning models for SR according to some aspects of the present disclosure.

FIG. 4 shows an example of a flow diagram that supports machine learning models for SR according to some aspects of the present disclosure.

FIG. 5 shows an example of a flow diagram that supports machine learning models for SR according to some aspects of the present disclosure.

FIG. 6 shows an example of a process flow that supports machine learning models for SR according to some aspects of the present disclosure.

FIG. 7 shows an example of a process flow that supports machine learning models for SR according to some aspects of the present disclosure.

FIG. 8 shows an example of a flow diagram that supports machine learning models for SR according to some aspects of the present disclosure.

FIG. 9 shows an example of a process flow that supports machine learning models for SR according to some aspects of the present disclosure.

FIG. 10 shows a block diagram of an example wireless communication device that supports machine learning models for SR according to some aspects of the present disclosure.

FIG. 11 shows a block diagram of an example wireless communication device that supports machine learning models for SR according to some aspects of the present disclosure.

FIGS. 12-15 show flowcharts illustrating example processes that support machine learning models for SR according to some aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to machine learning (ML) model usage for spatial reuse (SR). Some aspects more specifically relate to signaling between devices and device behavior to identify inputs to a ML model and utilize output of the ML model to perform wireless communications according to a SR procedure. In some aspects, a station (STA), an access point (AP), or both, may use an ML model to obtain one or more SR parameters, such as an overlapping basic service set (OBSS) preamble detection (PD) value or a threshold of detected interference below which the device may transmit at a lower transmit power. Inputs to the ML model, or the ML model itself, may be exchanged between devices.

In some aspects, an AP may transmit ML model information to a STA. The ML model information may include an indication of an ML model, one or more parameters defining the ML model (for example, weights of a neural network ML model), one or more inputs for the ML model, one or more outputs for the ML model, or any combination thereof. For instance, the AP may use the ML model to generate one or more outputs including one or more SR parameters and indicate these outputs to the STA for use in SR transmissions. In some aspects, the AP may transmit an indication of the ML model to the STA, and the STA may utilize the indicated ML model and one or more observations or measurements as inputs to the ML model. In some aspects, the AP may transmit an indication of the ML model and one or more observations or measurements (such as measurements or information reported by other APs, other STAs, or both), and the STA may utilize the indicated information and one or more local observations as inputs for the ML model. The outputs of the ML model may be used to perform SR transmissions. In some aspects, the AP also may advertise, enable, disable, or update indicated ML models.

Particular aspects of the subject matter described in this disclosure can be implemented to realize one or more of the following potential advantages. In some aspects, by providing signaling to exchange the ML model, inputs or outputs of the ML model, or reporting information from other devise that can be used as inputs for the ML model, the described techniques can be used to improve the effectiveness of SR procedures. For example, by using an ML model (and in some aspects, shared observations and measurements from other devices as inputs to the ML model), a transmitting device may more effectively generate SR parameters supporting SR transmissions, resulting in more effective use of available system resources, improved throughput, decreased latency, and improved user experience. Improved accuracy in selection of transmission parameters based on the ML model as described herein may result in improved reliability of wireless communications.

Additionally, or alternatively, SR parameters that are inferred from an ML model may improve the performance of a transmitting device (such as a transmitting STA), and may further overall improve system performance. This may occur because SR parameters selected without the ML model may improve individual performance at the cost of performance at another device or another BSS, while SR parameters selected with reference to the ML model provided by or updated by the AP may improve overall performance for multiple devices within a BSS or across multiple BSSs. When an AP disseminates an ML model across a BSS, the devices in the BSS may experience homogeneity in terms of performance and interference caused. This may be more effective than each STA independently choosing its SR parameters (such as OBSS PD values and therefore transmit power), resulting in non-homogenous behavior in terms of performance at the STAs and interference caused by one BSS to another.

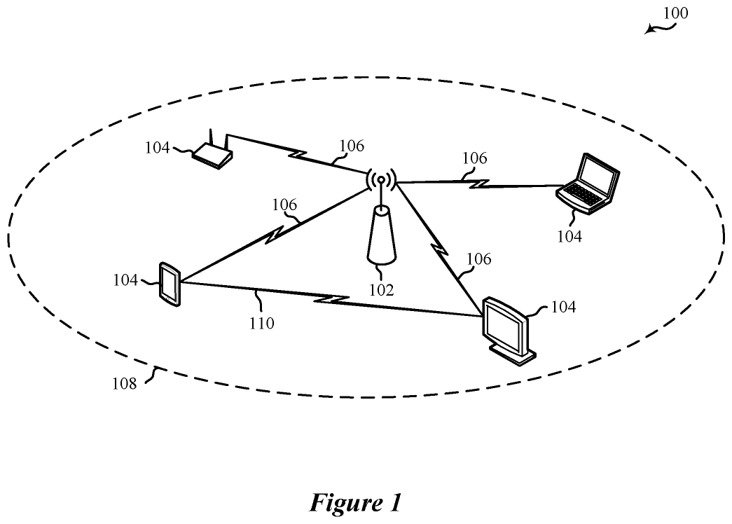

FIG. 1 shows a pictorial diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of wireless communication protocol standards (such as that defined by the IEEE 802.11-2020 specification or amendments thereof including, but not limited to, 802.11ay, 802.11ax, 802.11az. 802.11ba, 802.11bd, 802.11be, 802.11bf, and the 802.11 amendment associated with Wi-Fi 8). The WLAN 100 may include numerous wireless communication devices such as a wireless AP 102 and multiple wireless STAs1. While only one AP 102 is shown in FIG. 1, the WLAN network 100 also can include multiple APs 102. AP 102 shown in FIG. 1 can represent various different types of APs including but not limited to enterprise-level APs, single-frequency APs, dual-band APs, standalone APs, software-enabled APs (soft APs), and multi-link APs. The coverage area and capacity of a cellular network (such as LTE, 5G NR, etc.) can be further improved by a small cell which is supported by an AP 102 serving as a miniature base station. Furthermore, private cellular networks also can be set up through a wireless area network using small cells.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, personal digital assistant (PDAs), other handheld devices, netbooks, notebook computers, tablet computers, laptops, chromebooks, extended reality (XR) headsets, wearable devices, display devices (for example, TVs (including smart TVs), computer monitors, navigation systems, among others), music or other audio or stereo devices, remote control devices (“remotes”), printers, kitchen appliances (including smart refrigerators) or other household appliances, key fobs (for example, for passive keyless entry and start (PKES) systems), Internet of Things (IoT) devices, and vehicles, among other examples. The various STAs 104 in the network are able to communicate with one another via the AP 102.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified or indicated to users by a service set identifier (SSID), as well as to other devices by a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function for establishing or maintaining timing synchronization with the AP 102. The AP 102 may provide access to external networks to various STAs 104 in the WLAN via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some aspects, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some aspects, ad hoc networks may be implemented within a larger wireless network such as the WLAN 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to one or more of the IEEE 802.11 family of wireless communication protocol standards. These standards define the WLAN radio and baseband protocols for the PHY and MAC layers. The APs 102 and STAs 104 transmit and receive wireless communications (hereinafter also referred to as “Wi-Fi communications” or “wireless packets”) to and from one another in the form of PHY protocol data units (PPDUs). The APs 102 and STAs 104 in the WLAN 100 may transmit PPDUs over an unlicensed spectrum, which may be a portion of spectrum that includes frequency bands traditionally used by Wi-Fi technology, such as the 2.4 GHZ band, the 5 GHz band, the 60 GHz band, the 3.6 GHz band, and the 900 MHz band. Some examples of the APs 102 and STAs 104 described herein also may communicate in other frequency bands, such as the 5.9 GHZ and the 6 GHz bands, which may support both licensed and unlicensed communications. The APs 102 and STAs 104 also can communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac, 802.11ax and 802.11be standard amendments may be transmitted over the 2.4 GHZ, 5 GHZ or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHz, 160 or 320 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload.

Some APs 102 and STAs 104 may implement techniques for SR that involve participation in a coordinated communication scheme. According to such techniques, an AP 102 may contend for access to a wireless medium to obtain control of the medium for a TXOP. The AP 102 that wins the contention (hereinafter also referred to as a “sharing AP”) may select one or more other APs 102 (hereinafter also referred to as “shared APs”) to share resources of the TXOP. The sharing and shared APs 102 may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP 102 may partition the TXOP into multiple time segments or frequency segments each including respective time or frequency resources representing a portion of the TXOP, The sharing AP 102 may allocate the time or frequency segments to itself or to one or more of the shared APs 102. For example, each shared AP 102 may utilize a partial TXOP assigned by the sharing AP 102 for its uplink or downlink communications with its associated STAs

In some aspects of such TDMA techniques, each portion of a plurality of portions of the TXOP includes a set of time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of frequency resources that do not overlap with any frequency resources of any other portion of the plurality of portions. In such aspects, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs 102 and their respective BSSs, subject to appropriate power control and link adaptation. For example, the sharing AP 102 may limit the transmit powers of the selected shared APs 102 such that interference from the selected APs 102 does not prevent STAs 104 associated with the TXOP owner from successfully decoding packets transmitted by the sharing AP 102. Such techniques may be used to reduce latency because the other APs 102 may not need to wait to win contention for a TXOP to be able to transmit and receive data according to conventional CSMA/CA or EDCA techniques. Additionally, by enabling a group of APs 102 associated with different BSSs to participate in a coordinated AP transmission session, during which the group of APs 102 may share at least a portion of a single TXOP obtained by any one of the participating APs 102, such techniques may increase throughput across the BSSs associated with the participating APs 102 and also may achieve improvements in throughput fairness. Furthermore, with appropriate selection of the shared APs 102 and the scheduling of their respective time or frequency resources, medium utilization may be maximized or otherwise increased while packet loss resulting from OBSS interference is minimized or otherwise reduced. Various aspects may achieve these and other advantages without requiring that the sharing AP 102 or the shared APs 102 be aware of the STAs 104 associated with other BSSs, without requiring a preassigned or dedicated master AP 102 or preassigned groups of APs 102, and without requiring backhaul coordination between the APs 102 participating in the TXOP.

In some aspects in which the signal strengths or levels of interference associated with the selected APs 102 are relatively low (such as less than a given value), or when the decoding error rates of the selected APs 102 are relatively low (such as less than a threshold), the start times of the communications among the different BSSs may be synchronous. Conversely, when the signal strengths or levels of interference associated with the selected APs 102 are relatively high (such as greater than the given value), or when the decoding error rates of the selected APs 102 are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP 102 (or its associated STAs 104) to decode the preamble of the wireless packet and obtain the BSS color value carried in the wireless packet to determine whether the wireless packet is an intra-BSS packet or an OBSS packet. In this manner, each of the participating APs 102 and their associated STAs 104 may be able to receive and decode intra-BSS packets in the presence of OBSS interference.

In some aspects, the sharing AP 102 may perform polling of a set of un-managed or non-co-managed APs 102 that support coordinated reuse to identify candidates for future SR opportunities. For example, the sharing AP 102 may transmit one or more SR poll frames as part of determining one or more SR criteria and selecting one or more other APs 102 to be shared APs 102. According to the polling, the sharing AP 102 may receive responses from one or more of the polled APs 102. In some specific examples, the sharing AP 102 may transmit a coordinated AP TXOP indication (CTI) frame to other APs 102 that indicates time and frequency of resources of the TXOP that can be shared. The sharing AP 102 may select one or more candidate APs 102 upon receiving a coordinated AP TXOP request (CTR) frame from a respective candidate AP 102 that indicates a desire by the respective AP 102 to participate in the TXOP. The poll responses or CTR frames may include a power indication, for example, an RX power or RSSI measured by the respective AP 102. In some other examples, the sharing AP 102 may directly measure potential interference of a service supported (such as UL transmission) at one or more APs 102, and select the shared APs 102 based on the measured potential interference. The sharing AP 102 generally selects the APs 102 to participate in coordinated SR such that it still protects its own transmissions (which may be referred to as primary transmissions) to and from the STAs 104 in its BSS. The selected APs 102 may then be allocated resources during the TXOP as described above.

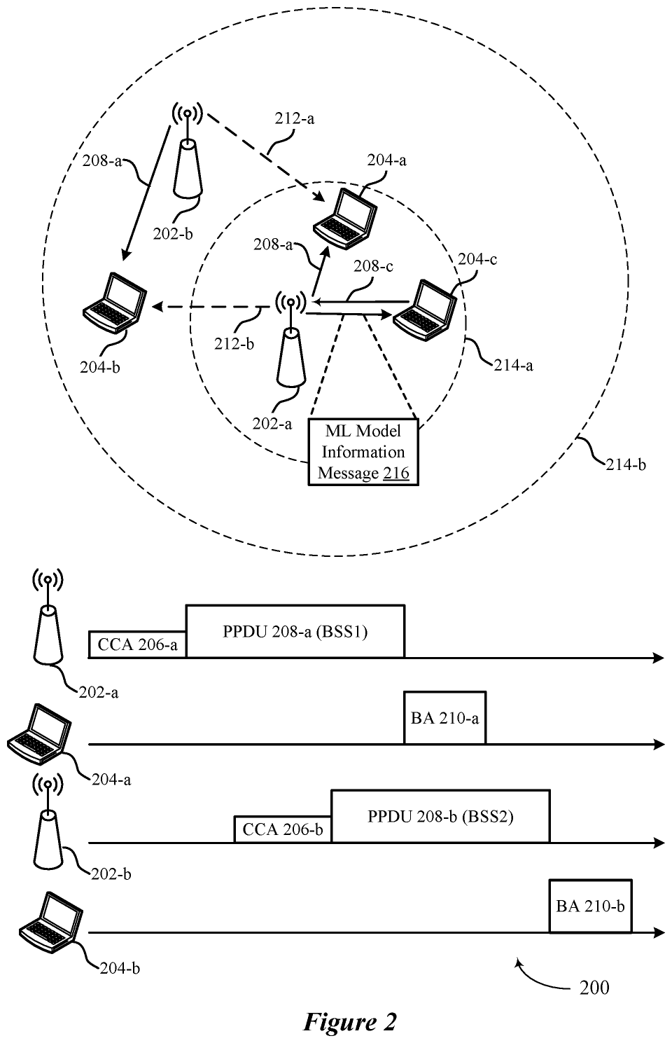

FIG. 2 shows an example of a pictorial diagram of another example wireless communication network 200 that supports machine learning models for SR according to some aspects of the present disclosure. The pictorial diagram shows that the other example wireless communication network 200 may include one or more wireless devices, which may be examples of corresponding devices described with reference to FIG. 1. For example, the other example wireless communication network 200 may include an AP 202-a, an AP 202-b, a STA 204-a, or a STA 204-b.

In some aspects, the other example wireless communication network 200 may support SR procedures. SR may refer to adjustments made by one or more devices to more efficiently use system resources by supporting concurrent transmissions across different BSS on the same channel without interfering with each other. For example, the AP 202-a may communicate with the STA 204-a, and the AP 202-b may communicate with the STA 204-b. In some aspects, the AP 202-b and the STA 204-b may correspond to a first BSS, and the AP 202-a and the STA 204-a may correspond to a second BSS. The AP 202-a may perform CCA 206-a and may transmit a PPDU 208-a (for example, corresponding to the first BSS, which may be referred to as BSS1), and the STA 204-a may transmit a BA 210-a responsive to the PPDU 208-a. Similarly, the AP 202-b may perform a CCA 206-b and may transmit a PPDU 208-b (for example, corresponding to the second BSS, which may be referred to as BSS2), and the STA 204-b may transmit a BA 210-b responsive to the PPDU 208-a.

Transmissions within a sensing range 214-b of the AP 202-b may result in interference. For example, if the PPDU 208-b and the PPDU 208-a overlap at least partially in time, then the PPDU 208-a and the PPDU 208-b may cause interference 212 (for example, the STA 204-b may sense interference 212-a generated by the transmission of the PPDU 208-a, and the STA 204-a may sense interference 212-b generated by the transmission of the PPDU 208-b). To avoid such interference, the AP 202-b may detect the PPDU 208-a (for example, via the CCA 206-b), and may refrain from transmitting PPDU 208-b.

In some aspects, the AP 202-b may be capable of transmitting the PPDU 208-b at a lower transmit power that would not generate enough interference 212-b to negatively impact the STA 204-a. If the STA 204-b refrains from transmitting the PPDU 208-b, this may result in inefficient use of available system resources, decreased throughput, increased system latency, and decreased user experience. In such examples, the UE may AP 202-b may transmit PPDU 208-b if transmissions such as the PPDU 208-a originate from devices outside of the sensing range 214-a (for example, may reduce the size of a sensing range 214), or if the PPDU 208-b is detected from an OBSS (for example, the OBSS1). In such examples, the AP 202-b may transmit the PPDU 208-b at a lower transmit power, and may communicate with the STA 204-b despite the PPDU 208-b overlapping in time with the PPDU 208-a, according to a SR procedure.

In a SR procedure, a transmitting device (for example, the AP 202-b) may determine scenarios in which the AP 202-a is permitted to transmit despite detecting potential interference (for example, the PPDU 208-a). For example, the AP 202-b may perform OBSS preamble detection (PD) SR, in which case the AP 202-b may identify non-SR group (SRG) OBSS PD, or SRG OBSS PD. In some aspects, the AP 202-b may support parametrized SR (PSR). For example, the AP 202-b may determine one or more parameters (for example, a threshold energy level, whether a detected transmission is OBSS, among other examples), and if detected signaling (for example, PPDU 208-a from BSS1) satisfies the parameters (for example, which may be defined in one or more standards or configured at a transmitting device), then the AP 202-b may proceed to transmit the PPDU 208-b. In some aspects of SR, the AP 202-b may reduce its transmit power by an amount calculated based on the one or more parameters.

In some aspects, a transmitting device may support one or more artificial intelligence (AI) or machine learning (ML) models. As described herein, the term ML model may refer to an ML model, an AI model, an AI/ML model, or any combination thereof. An AP may support various applications of ML models. In some aspects, an AP 202 may support one or more ML models at one or more STAs 204.

As described herein, the AP 202-b may support one or more STAs 204 (for example, including the STA 204-c) by providing ML model information (for example, via a ML model information message 216). In some aspects, the AP 202-a may transmit the ML model information message 216, which may include gathered information, which may be utilized by the STA 204-c as inputs to the ML model (for example, the STA 204-c may be hardcoded or preconfigured with the ML model, which may not be provided by the AP 202-a in such examples). In such examples, the STA 204-c may input information received in the ML model information message 216 into the ML model, or may input locally gathered observations (for example, measurements made locally by the STA 204-c).

In some aspects, the AP 202-a may indicate the ML model itself to the STA 204-c (for example, an identifier of preconfigured or predefined ML model from a set of ML models, or configurations defining the structure of the ML model, parameters of the ML model, among other examples). In such examples, the STA 204-c may input local measurements, or information exchanged with other STAs 204.

In some aspects, the AP 202-a may indicate both the ML model itself, and information such as input values for the ML model. Such information provided by the AP 202-a may be provided in the ML model information message 216, or via other signaling. In some aspects, the AP 202-a may gather such information from other APs 202, or from other STAs 204. The STA 204-c may input, to the ML model, local measurements performed by the STA 204-c, information exchanged between STAs 204, information received from the AP 202-a, or a combination thereof.

As described herein, the STA 204-c may request download of the ML model, and the AP 202-a may download the ML model to the STA 204-c based on the request. In some aspects, the AP 202-a may download the ML model to the STA 204-c without the STA's request. In some aspects, the AP 202-a also may manage the model in use (for example, provide updates, changes, new parameters, instructions to switch between models, or a combination thereof).

In some aspects, the AP 202-a may support signaling to exchange information, measurements, or observations. For example, STAs 204 may exchange local observations (for example, STAs 204 at the edges of a BSS may report observed interference levels). Such exchange of information between STAs 204 (for example, which may be used as inputs for the ML model) may support ML-capable STAs 204 in collecting information that is not locally available to the ML-capable STAs 204. STAs 204 may exchange feedback information (for example, a first AP 202-b may indicate, to a second AP 202-a, an average interference experienced in a BSS of the second AP 202-b). Such information may support ML-capable STAs 204 to determine an impact of an ML model on surrounding STAs 204 and APs 202. In some aspects, the exchanged information (for example, received from other STAs 204, or from APs 202) may be used as inputs to the ML model. Based on the ML model, a device (for example, a STA 204-c) may perform SR procedures (for example, outputs of the ML model may be used to determine parameters for sensing potential interference, transmit power for transmission of PPDU 208-c that overlap in time with other PPDUs, among other examples, as described herein).

In some aspects, the ML models may be downloadable. APs 202 may share ML model components with associated STAs 204, or other friendly/coordinating APs 202 (such as. APs that support coordinated SR). STAs 204 may download the ML model and use the model for making decisions related to SR. Downloading the ML models may be independent from signaling exchange for inputs to the ML model (for example, some devices may download the ML model without exchanging information with other devices, some devices may exchange information and use such information as an input to the ML model without downloading it, and some devices may download the ML model and exchange information or the ML model with other devices).

For instance, as described herein, the STA 204-c may monitor for interference (for example, may perform a CCA). The STA 204-c may extract information from the physical or media access control (MAC) header of a detected PPDU 208, and may use such extracted information or other observations or measurements as inputs to the ML model. The ML model may generate one or more outputs, such as a SR parameter (for example, an OBSS PD value of −62 dB, and a transmit power of 16 dBm). The STA 204-c may set the OBSS PD to −62 dBm, and may contend for access to one or more wireless channels according to the SR parameter value (for example, may monitor for sensed interfering or secondary transmissions that satisfy the OBSS PD of −62 dBm). If sensed interference from other devices satisfies the reuse parameter value, then the STA 204-c may send a transmission (for example, PPDU 208-c) at a transmit power determined by the ML model (for example, 16 dBm). In some aspects, the allowed transmit power when using the ML model may be greater than the transmit power allowed by non-ML SR techniques. In some aspects, the STA 204-c may elect to transmit at the greater of the two permissible transmit power values, whereas in other aspects, the STA 204-c may elect to transmit at the smaller of the two permissible transmit power values. In some aspects, the inputs to the ML model (for example, observations and information detected in a physical or MAC header) may result in outputs including an OBSS PD value (for example, −82 dBm) and a transmit power (for example, 21 dBm). However, if detected interference (for example, another PPDU 208) is sensed that exceeds the SR parameter (for example, the OBSS PD value of −84d dBm), then the STA 204-c may refrain from transmitting the PPDU 208-c.

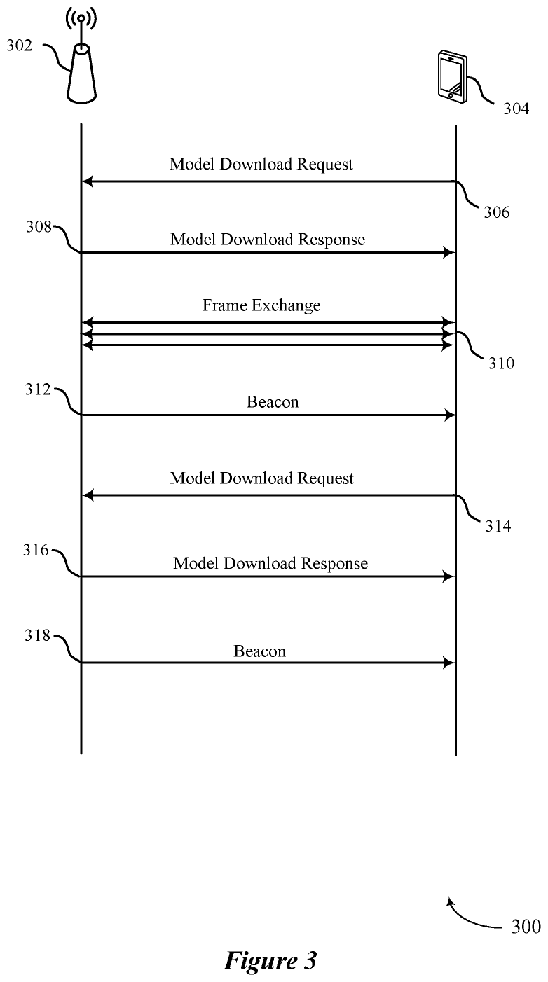

FIG. 3 shows an example of a process flow 300 that supports machine learning models for SR according to some aspects of the present disclosure. The process flow 300 may be conjunctively performed by two wireless communication devices, such as an AP 302 and a STA 304, which may each be an example of an AP 102 or a STA 104.

In some aspects, the AP 302 may offer a downloadable ML model to associated STAs (for example, such as the STA 304). For example, at 306, the STA 304 may transmit a model download request to the AP 302. At 308, the AP 302 may transmit a model download response (for example, downloading the ML model to the STA 304.

The ML model input may rely on local information. For example, ML inputs may include a number of STAs observed above a threshold (for example, RSSI of −50 dBm), an average SINR for a threshold amount of time (for example, 20 PPDUs), a distance to the AP 302, a distance to a threshold quantity (for example, 3) of nearest interferences, an average interference level observed during a CCA, a success rate for a past threshold quantity of PPDUs sent according to a chosen OBSS PD level, a transmit power used for a past quantity (for example, 20) of PPDUs, a quantity of RBO interruptions for the latest PPDU transmitted, among other examples. The STA 304 may input such input values to the ML model, and generate one or more outputs (for example, an OBSS PD level) for SR.

At 310, the STA 304 may perform a frame exchange (for example, may transmit one or more frames) using ML-model-derived SR parameters (for example, according to a reduced transmit power, for instance).

In some aspects, the network may advertise available ML models, or may indicate updates to the ML model. For instance, at 312, the AP 302 may transmit a message (for example, a beacon) that includes critical update information to a downloaded ML model, or that indicates availability of a new ML model. In some aspects, at 314 (for example, based on the message received at 312), the STA 304 may transmit a model download request (for example, may request another ML model based on the indication of the new ML model indicated via the beacon). At 316, the AP 302 may transmit a model download response indicating the ML model for download by the STA 304.

In some aspects, the AP 302 may disable an ML model. For example, if the SR is not successful, or results in increased interference, then at 318 the AP 302 may transmit a beacon or a probe response frame including an indication of disabling the ML model or disabling SR at the STA 304.

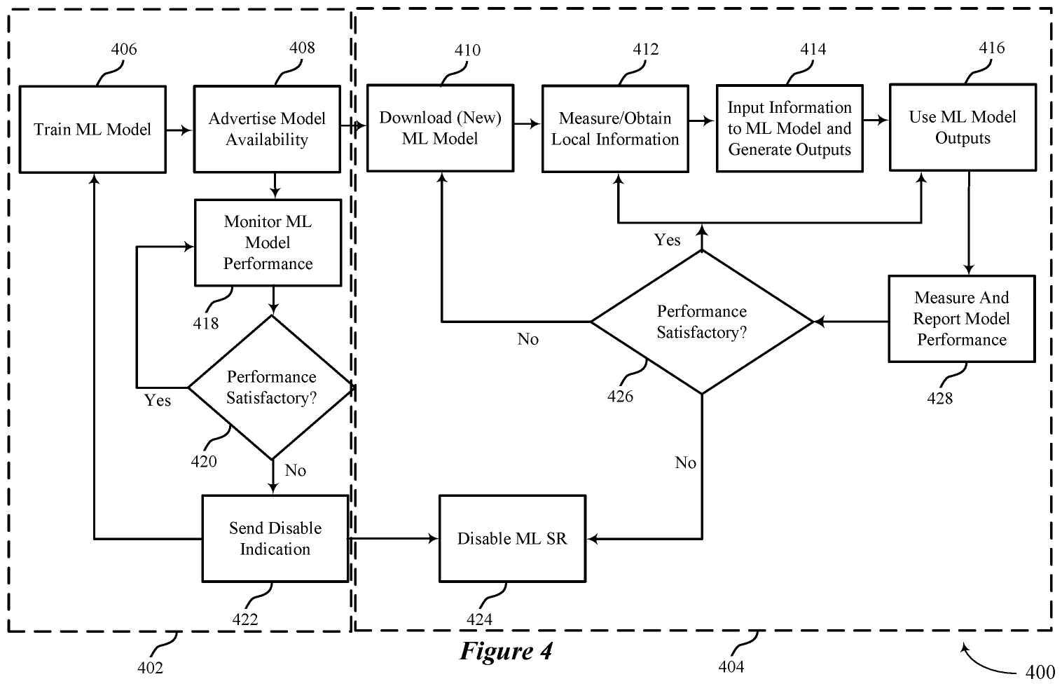

Model usage at the STA 304 may be further described with reference to FIG. 4.

FIG. 4 shows an example of a flow diagram 400 that supports machine learning models for SR according to some aspects of the present disclosure. The flow diagram 400 may be implemented by one or more devices, such as an AP 402 and a STA 404, which may each be an example of an AP 102 or a STA 104.

At 406, the AP 402 may train an ML model. At 408, the AP 402 may advertise the model availability (for example, may transmit a message such as a beacon, a probe response frame, an operating mode notification frame, or any other defined action frame, such as the beacon as described with reference to FIG. 3). The AP 402 may download the ML model to the STA 404 (for example, at 410). The AP 402 may communicate with the STA 404 based on the ML model, and at 418 the AP 402 may monitor the ML model performance. At 420, the AP 402 may determine whether the ML model performance is satisfactory (for example, if interference is below a threshold, if throughput or latency satisfy a threshold, etc.). At 422, if the performance is not satisfactory, (420—No) the AP 402 may send a disable indication to the STA 404 (for example, disabling the ML model downloaded at 410). If the performance of the ML model is satisfactory (420—Yes), then the AP 402 may continue to monitor the ML model performance at 418.

At 410, the STA 404 may download the ML model or a new ML model from the AP 402. At 412, the STA 404 may measure or otherwise obtain local information (for example, or may receive input information from other STAs or from the AP). At 414, the STA 404 may input information to the ML model and generate outputs (for example, an OBSS PD level). At 416, the STA 404 may use the ML model outputs (for example, an inference) in performing SR (for example, as described with reference to FIGS. 2-3. At 428, the STA 404 may measure and report model performance, and may determine whether performance is satisfactory at 426. If performance is not satisfactory (426—No), then at 424, the STA 404 may disable the ML model and/or SR (for example, autonomously, or based on a disable indication sent at 422). In some aspects, if performance is not satisfactory, then at 410 the STA 404 may download another ML model. If performance of the ML model is satisfactory (426—Yes), then at 412 the STA 404 may continue to measure or obtain local information and use the ML model outputs.

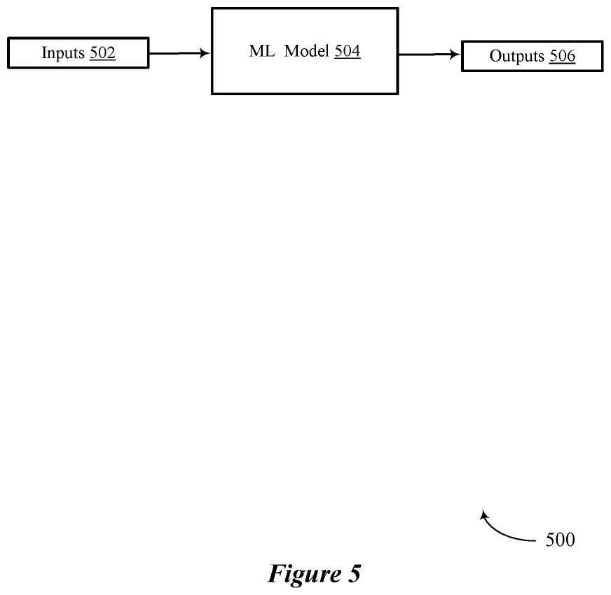

Model considerations including inputs and outputs are described in greater detail with reference to FIG. 5.

FIG. 5 shows an example of a flow diagram 500 that supports machine learning models for SR according to some aspects of the present disclosure. The flow diagram may be implemented by a wireless device, such as an AP 102 or a STA 104.

A wireless device may perform SR according to an ML model 504. The device may input on or more inputs 502 into the ML model, to generate one or more outputs 506. The outputs 506 may be used to perform the SR.

A model inference (for example, a candidate or proposed parameter value for performing SR) may be an input 502, or an output 506, or both. In some aspects, a model inference may be the same thing as (for example, included in) the outputs 506. For instance, the inputs 502 may include one or more observations (for example, local observations or shared observations), and may output an inference (for example, a SR parameter).

In some aspects, the output 506 may be an estimated metric, such as an estimated throughput, and the model inference may be derived from the model input. For instance, the ML model 504 may be designed to provide the estimated throughput for a chosen OBSS PD level, which may be fed to the ML model as an input 502. Thus, the inference (for example, candidate SR parameter) may be included in the inputs 502, and the output 506 may be an estimated throughout for the candidate SR parameter. The estimated throughput may support a determination of whether the device should use the candidate SR parameter for SR. One invocation of the ML model 504 may give the estimated throughput only for the SR parameter (for example, an OBSS PD) inputted to the ML model. Different parameters (for example, different OBSS PD levels) may be evaluated for estimated throughputs, and the OBSS PD level that yields the highest throughput may be the model inference (and may be selected by the device for SR). In such example, the ML model may act as a function approximator.

The ML model 504 may support various aspects (for example, natures) of the ML model inference. The ML model inference may be an SR parameter, such as an OBSS PD level, a PSR value, or a transmit power value, or a range of transmit power values, among other examples. For instance, the inference of the ML model 504 may provide a reward or value for different choices (for example, candidates) of a SR parameter, and the inference may be the SR parameter that improves the reward or value (for example, the highest reward value or the most improvement).

In some aspects, the ML model inference may be an action. For example, the output 506 of the ML model 504 may be an indication of whether to transmit a secondary PPDU or not during an ongoing inter-BSS PPDU. The ML model 504 may be invoked during every SR opportunity (for example, when a STA detects an inter-BSS PPDU). Similarly, the output 506 of the ML model 504 may be whether an AP may allow a PSR during a TB PPDU. The ML model 504 may then be invoked by the AP before every trigger frame transmission.

In some aspects, a single ML model 504 may provide multiple inferences of a same or different nature. For example, a single ML model 504 may provide an inference for both an OBSS PD level and a transmit power level. In some aspects, a single ML model 504 may provide an inference for a SR parameter (for example, an OBSS PD) and an action (for example, whether the PPDU should be end aligned with a secondary PPDU). An inference, such as an action, may be an input 502 (for example, a candidate action, such as transmission under certain conditions or end alignment), or an output (for example, an indication of whether transmission or end alignment should be performed). An inference, such as an action or a candidate value, may be a single input or may be input along with other inputs, may be a single output, or may be an output of a set of outputs (for example, an action and a SR parameter).

In some aspects of model structure, the model inference may be a SR parameter. In such examples, the inputs 502 may include one or more observations (for example, shared observations from other STAs or APs, or local observations performed by the device), and the outputs 506 may include the inference which may be a SR parameter (for example, an OBSS PD value, a transmit power, a PSR, or the like). In some aspects, model inference may be an action or a decision, in which case the inputs 502 may include one or more observations (for example, shared or local observations or measurements), and the outputs may include the inference (for example, a determination of whether to transmit, whether to end-align, whether to increase preamble detection, or any combination thereof). In some aspects, the model inference may be a SR parameter and an action. In such examples, the inputs 502 may include one or more local or shared observations, and the outputs 506 may include a SR parameter (for example, an OBSS PD, a transmit power, a PSR, among other examples) and an action or decision (for example, a determination of whether to transmit, whether to end-align, whether to increase preamble detection, or any combination thereof).

In some aspects, the model inference and the model output may not be the same, and the inference may be obtained by feeding multiple options into the ML model 504 as the model inputs 502. For example, the inputs 502 may include one or more shared and local observations, and a candidate SR parameter (for example, an OBSS PD, a transmit power, a PSR, or the like), resulting in outputs 506 including a performance metric (for example, a throughput, delay, success or error rate, among other examples) corresponding to the candidate SR parameter (for example, the inference). In some aspects, the model inference may be an action or decision included in the inputs 502. In such examples, the inputs 502 may include one or more observations (for example, local and shared observations) and a candidate action (for example, a determination of whether to transmit, whether to end-align, whether to increase preamble detection, or any combination thereof). The resulting outputs 506 may include a performance metric (for example, a throughput, delay, success or error rate, among other examples) corresponding to the candidate SR parameter (for example, the inference). In some aspects, the model inference may be a SR parameter and an action. In such examples, the inputs 502 may include one or more local or shared observations, and an inference (for example, a candidate SR parameter such as an OBSS PD, a transmit power, or a PSR). The outputs 506 may include another inference such as an action (for example, a determination of whether to transmit, whether to end-align, whether to increase preamble detection, whether to allow a PSR, or any combination thereof).

A transmitting device may implement outputs 506 according to a time scale corresponding to the model invocation. For example, outputs 506 may apply in the short-term (for example, per PPDU or TXOP). One or more values (for example, outputs 506) of SR parameters (for example, OBSS PD or transmit power) may depend on characteristics of a primary PPDU (for example, a PPDU 208-c as described with reference to FIG. 2). For example, the SR parameters may depend on a transmit power, modulation and coding scheme (MCS), PPDU type, distance of a STA 54, a receiver, a distance to another device, etc. As a result, for every primary transmitter and primary receiver combination, a threshold SR parameter value (for example, OBSS PD and transmit power) may change. Furthermore, if every PPDU in a TXOP uses different parameters, then the SR parameters may change within a TXOP. Short-term time scales for application of outputs 506 may result in performance improvement.

In some aspects, outputs 506 may apply in a longer-term manner. In some aspects, STAs 54 may benefit from more simplicity (for example, even at the expense of performance). In such cases, the ML model 504 may be designed to yield an inference that remains valid for a long timer (for example, multiple TXOPs). The SR parameters (for example, outputs 506) may be the same for all STAs 204 or the inference may be a map between STAs 204 and SR parameters. In general, the more generalized model may decrease performance of the ML model, but may conserve computational resources, and decrease latency, among other results. When an AP 52 downloads the ML model 504 onto associated STAs 54, the AP 52 may specify whether the model applies on a per-TXOP or per-PPDU level, or a long-term basis (for example, a quantity of TXOPs or a quantity of PPDUs). Additionally, the STAs 54 may request ML models on a long-term basis or short-term basis based on capability or other constraints. For instance, a STA 54 may report a capability to support various timelines or aspects of ML models, or specific ML models or timelines, or may request specific long-term or short-term ML models 504).

In some aspects, the ML model 504 may yield SR parameters that are valid for several TXOPs. The model inference may include a mapping between a primary transmitter-receiver pair and the SR parameters to use. For instance, SR parameters for N different transmitter-receiver pairs may be illustrated by Table 1.

TABLE 1

| Identifier for | | | Baseline |
|---|---|---|---|
| Primary Transmitter- | OBSS-PD | Transmit | Transmit |
| Receiver Pair | level | Power | Power |
| i1 | −75 dBm | 14 dBm | 14 dBm |
| i2 | −82 dBm | 21 dBm | 21 dBm |
| i3 | −62 dBm | 18 dBm | 1 dBm |
| i4 | −72 dBm | 15 dBm | 11 dBm |
| . . . | . . . | . . . | . . . |
| iN | −82 dBm | 12 dBm | 21 dBm |

In some aspects, one or more STAs 54 may be configured with a baseline transmit power. A STA 54 may select either the output 506 transmit power, or the baseline transmit power, depending which value is higher (for example, the STA 54 may use the output 506 as long as it is greater than or equal to the baseline transmit power. For instance, the transmitter in the transmitter-receiver pair i1 may transmit according to a transmit power of 14 dBm if a detected secondary transmission is less than-75 dBm, instead of the baseline transmit power of 14 dBm. Similarly, the transmitter in the transmitter-receiver pair i3 may transmit according to a transmit power of 18 dBm if a detected secondary transmission is less than-62 dBm, instead of the baseline transmit power of 1 dBm. However, the transmitter in the transmitter-receiver pair iN may transmit according to a transmit power of 21 dBm if a detected secondary transmission is less than-82 dBm, instead of the output 506 transmit power of 12 dBm.

In some aspects, one or more APs 102 may configure one or more STAs 104 with the baseline transmit power values. In some aspects, each STA 104 may use the OBSS PD model to compute a baseline transmit power. If the identifier corresponding to a primary PPDU does not exist in a parameter map, then the STA 104 may use a baseline SR parameter (for example, the baseline transmit power). In some aspects, the model or the AP may provide a default transmit power to use if the ML model does not provide the information.

ML model 504 may take various forms. For example, an ML model may have a fixed input/output relationship. In some other examples, the ML model 504 may be based on assigned scores for specific actions and the action-selection strategy (for example, a multi-armed bandit relationship). Such actions may include a set of possible OBSS PD levels (for example, −62 dBm, −61 dBm, −82 dBm, etc.), or a set of OBSS PDs and transmit power combinations (for example, [−62 dBm, 21 dBm], [−62 dBm, 20 dBm], etc.). A score may be associated with each action. The score may be a fixed value for each action or may be a distribution. Transmitting devices (for example, APs 102 or STAs 104) may select a given action based on the score. For example, the transmitting device may always select the highest value, or may implement a greedy selection (for example, select the highest score a percentage of the time, and randomly select another score value a remainder of the time), an equal probability sampling, or a Thompson sampling, among other examples. An AP 102 may observe the performance of various STAs 104 that download the ML model 504, and may modify scores associated with each action based on the observed performance.

As described herein, the inputs 502 may include local observations made by one or more devices. For example, the ML model 504 may rely on locally available observations. One or more standards documents may specify, or one or more APs 102 may signal, which local observations a STA 104 is to use as an input 502 to the downloaded ML model 504. For instance, a first STA 104 may download the ML model 504. The STA 104 may intend to transmit to a second STA 104. Examples of local observations that can be used as inputs 502 for the ML model 504 may include prominent interferers (for example, STAs 104 corresponding to an RSSI at the first STA 104 is greater than a threshold, which may be configured by the AP 102). The prominent interferers may include a quantity of in-BSS STAs 104 with an RSSI at the first STA 104 that is greater than the threshold, a quantity of OBSS STAs with RSSI at the first STA 104 that is greater than the threshold, a quantity of APs 102 detected by the first STA 104, a quantity of in-BSS STAs that account for STAs 104 belonging to a multiple basic service set identifier (MBSSID) or cohosted set, an identify of prominent interferers (for example, a MAC address or device identifier such as a STA identifier in a high efficiency signal B (HE-SIG-B) field).

In some aspects, the local observations for the inputs 502 may include a distance between the first STA 104 and other STAs 104. For instance, the local observation may include a distance between the first STA 104 and one or more intended receivers, a distance between the first STA 104 and prominent interferers, or can be estimated based on an RSSI of PPDUs received from the other STAs (for example, if a transmit power is known by the first STA 104). The observations may include an SINR of past PPDUs received by the first STA 104 from the second STA 104, a success or error rate of past PPDUs transmitted by the first STA 104 to the second STA 104, a quantity of retransmission for past PPDUs, or a quantity of backoff countdown interruptions experienced by the first STA 104 when transmitting past PPDUs. In some aspects, the observations may include information from the primary PPDU, such as a PPDU type, an MCS, a distance of the first STA 104 from a PPDU transmitter, a distance of the first STA 104 from a PPDU receiver (for example, another STA 104), an RSSI of another STA 104 PPDU at the first STA 104, or an indication of whether a receiver address (RA) matches another STAs 104 association identifier (AID), among other examples. In some aspects, the observations may include performance metrics, such as throughput, delay, error rate, success rate measured during a time window (for example, which may be configured by an AP 102), a duration or start and end time of the window, or any combination thereof.

In some aspects, the inputs 502 may include information gathered from other STAs 104 (for example, exchanged via OTA signaling), such as local observations or local measurements of another STA 104. A reference STA 104 (for example, a non-AP STA 104) may solicit a subset of local observations or measurements from specific STAs 104, or from other APs 102. In some aspects, STAs 104, non-AP STAs 104, or APs 102, may send a subset of local observations or measurements to the reference STA 104 in an unsolicited event-based or periodic manner. In some aspects, the inputs 502 may include feedback from another STA 104. Feedback from neighboring devices or from neighboring BSSs may be useful in determining an impact of a chosen SR parameter on OBSSs. Such feedback may include an interference power from a reference BSS (such as a BSS to which the feedback is sent), a quantity of errors due to STAs 104 from the reference BSS, a distance to a reference AP 102, a binary indication on whether the reference BS is causing interference, or a combination thereof. As described herein, a neighboring device may refer to associated APs 102, neighboring APs 102, neighboring in-BSS STAs 104, OBSS STAs 104, or some peer to peer STAs 104, among other examples.

In some aspects, an AP 102 may relay feedback from a neighboring BSS to its associated STAs 104. When an AP 102 receives feedback from multiple neighboring BSSs, the AP 102 may combine a received feedback before relaying (for example, an average interference or threshold interference). The inputs 502 may include feedback from other STAs 104, which may be solicited or unsolicited. For example, an AP 102 that downloads ML models 504 onto associated STAs 104 may periodically poll the associated STA 104 and/or neighboring APs 102 to collect solicited feedback. An AP 102 that experiences increased interference or increased number of collisions due to an AP BSS may provide unsolicited feedback to the AP 102. In some aspects, two APs 102 may negotiate a periodic exchange of unsolicited feedback information. In some aspects, if a first AP 102 determines that another AP 102 uses a ML model 504, the first AP 102 may periodically send unsolicited feedback to the other AP 102.

Devices may perform model management for the ML model 504. Information collected from other STAs 104 may be used to manage SR in a BSS. For example, if a neighboring BSS reports high interference levels or a large quantity of collisions caused by the reference BSS, the reference BSS may disable the SR model. If some associated STAs 104 report increased error rates or collisions due to the SR ML model usage, the AP 102 may disable the SR usage (for example, or use of the ML model 504) in the BSS of the AP 102. Disabling the ML model 504 may be temporary (for example, disabling or pausing the ML model 504 for a specified time, which may be configured or indicated by the AP 102), or permanent (for example, the ML model 504 may be disabled until explicitly enabled again), or periodic (for example, the ML model 504 may be disabled (or enabled) during a specific time window, such as specific target wake time (TWT) service periods (SP) s). Based on gathering such information (for example, from other BSSs or associated STAs 104), an AP 102 may disable SR, machine learning-based SR, or both.

In some aspects, devices may support multiple ML models 504. An AP 102 may have different SR ML models 504 for different purposes. Different versions of the ML model 504 may have different structures. Differences may be defined in terms of input structure, output structure, or model complexity and size, among other examples. The AP 102 may have different ML models for different ranges of input values and network conditions. For example, the AP 102 may have a first ML mode 504 for dense scenarios and a second ML model 504 for light scenarios. The AP 102 may have different ML models 504 for different SR schemes (for example, for non-SRG SR, SRG SR, and PSR). The AP 102 may download different ML models 504 to a STA 104 for different access categories (ACs), traffic identifiers (TIDs), stream classification service identifiers (SCSIDs), or other traffic characteristics. For example, devices may support more aggressive ML models 504 for latency-sensitive traffic, and less aggressive ML models 504 for latency-tolerant traffic. An AP 102 may download different ML models 504 to different STAs 104. For example, STAs 104 located close to the AP 102 may receive one version of an ML model 504 while mobile STAs 104 may receive another ML model 504. Similarly, low-capability devices may receive smaller or simpler ML models 504, while high-end or high throughput or high capability devices may receive a larger or more complex ML model 504. In some aspects, battery powered devices may receive smaller or simpler ML models 504, while wall powered devices may receiver larger or more complex ML models 504.

Some wireless devices may perform model tuning of an ML model 504. An AP 102 may dictate whether the STAs 104 are permitted to tune (for example, train or refine) an ML model 504. The AP 102 may specify whether STAs 104 that download the ML model 504 can use new data to modify the model parameters of the ML model 504. For example, if the AP 102 observes unfairness across associated STAs 104, the AP 102 may disable model tuning. In some aspects, if the AP 102 observes edge user with poor performance resulting from a downloaded ML model 504, the AP 102 may allow model tuning. The AP 102 may indicate whether model tuning is allowed (for example, when downloading the ML model 504 to each STA 104, or via separate signaling).

In some aspects, one or more devices may support federated learning. In such aspects, devices that tune the ML model may upload the tuned model (e.g., mode parameters) to a model aggregator. The model aggregator may aggregate the ML models received from devices and disseminate the aggregated models to the uploading devices. In some aspects, the model uploads may be provided by the non-AP STAs or non-AP MLDs and AP may take the role of a model aggregator.

In some aspects, the AP 102 may provide updated ML models 504 to STAs 104. Providing updated ML models (such as, an aggregated model or a retrained model or a model suited for current network conditions) 504 may be based on certain triggers (for example, if a new STA 104 enters the BSS, if a new AP 102 is detected in a vicinity, if traffic profile changes at a STA 104, or if STAs 104 request updated ML models 504. When a new ML model 504 is available, the AP 102 may advertise this information to the STAs 104. For example, an AP 102 may use the critical update framework to notify the STAs 104.

In some aspects, an AP 102 may set bonds on the SR parameters used by the STAs 104. For example, the AP 102 may indicate, to the STA 104, that an output 506 such as an OBSS PD level inferred by the ML model is to satisfy a threshold, such that OBSS PD_{MIN}≤OBSS PD_{ML}≤OBSS PD_{MAX}, where OBSS PD_{MIN} indicates an upper threshold OBSS PD, OBSS PD_{ML} indicates an output 506 of the ML model 504, and OBSS PDₘₐₓ indicates a lower threshold OBSS PD. In some aspects, the AP 102 may indicate that an output 506 such as a transmit power inferred by the ML model 504 is to satisfy a rule such that TX PWR≤min (TX PWR_{MAX}, max (TX PWR_{ML}, TX PWR_{baseline})), where TX PWR_{MAX} indicates an upper threshold transmit power, TX PWR_{ML} indicates a transmit power that is an output 506, and TX PWR_{MIN} indicates a lower threshold transmit power. Such bounds may imply that if the ML model 504 infers a transmit power level that is less than a baseline transmit power (for example, which may be configured or calculated by the STA 104), the transmitter may revert to a baseline or default SR model. On the other hand, if the ML model 504 infers a transmit power level greater than the baseline transmit power, the transmitter may use the output transmit power level as long as it does not exceed the upper threshold transmit power. The upper threshold transmit power may be a constraint that is dictated by one or more standards, regulations, an AP 102, or a device capability.

In some aspects, the downloadable ML model 504 may be based on reinforcement learning (RL). To train, or retrain, an RL model, an action chosen by a peer STA 104 and/or a reward information corresponding to the action may be available to the other peer. The agent may include or piggyback selected actions in frames transmitted to the peer STA 104. The per STA 104 may include/piggyback reward information in frames sent to the agent. IF such reward information indicates that such would be beneficial, the STA 104 may train or update the ML model 504.

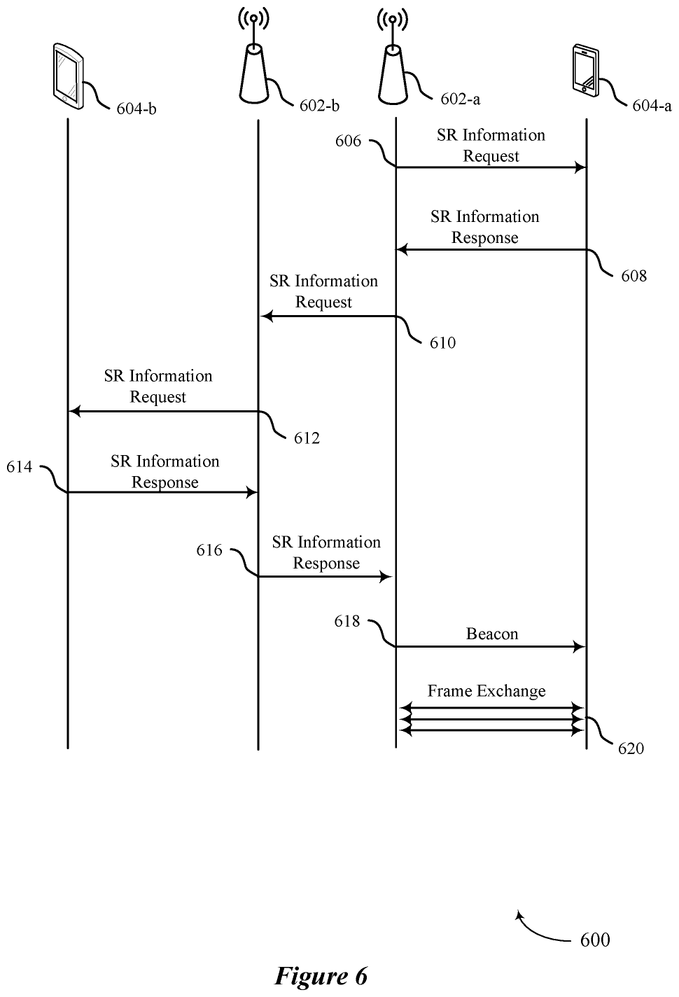

In some aspects, APs 102 may coordinate information or observations related to the ML model 504, as described in greater detail with reference to FIG. 6.

FIG. 6 shows an example of a process flow 600 that supports machine learning models for SR according to some aspects of the present disclosure. The process flow may include one or more devices, such as an AP 602-a, an AP 602-b, a STA 604-a, and a STA 604-b, which may each be examples of an AP 102 or a STA 104.

In some aspects, an AP 602 may collect information from associated STAs 604 and neighboring APs 602 to determine a range of SR parameters (for example, an OBSS PD range). At 606, the AP 602-a may transmit an SR information request to the STA 604-a. The SR information request may request information from the STA 604-a regarding a quantity of APs 602 observed by the STA 604-a, or a quantity of RBO interruptions, among other examples.

At 608, the STA 604-a may transmit an SR information response. The SR information response may include the information requested at 606 (for example, a quantity of APs 602 observed, which may be one, and a quantity of interruptions, which may be three, for instance).

At 610, the AP 602-a may transmit an SR information request to the AP 602-b. The SR information request may include a request for information such as an interference experienced due to the BSS of the AP 602-a, a quantity of collisions due to the OBSS corresponding to the AP 602-a (for example, the BSS of the AP 602-b), a distance from the AP 602-b to the AP 602-a, among other examples. At 612, the AP 602-b may transmit an SR information request to one or more STAs 604, including the STA 604-b. The SR information request may indicate that the STA 604-b is to report interference experienced due to the AP 602-a or the STA 604-a, or a quantity of collisions due to the AP 602-a or the STA 604-a, among other examples.

At 614, responsive to the SR information request received at 612, the STA 604-b may transmit an SR information response. The SR information response may indicate the information requested by the SR information response, such as an interference increase due to the AP 602-a and the STA 604-a (for example, 5 dB), a quantity of collisions due to the AP 602-a and the STA 604-a (for example, 10), a distance to the AP 602-a (for example, 7 m), or any combination thereof.

At 616, responsive to the SR information request received at 610, the AP 602-b may transmit the SR information response, conveying the information reported by the STA 604-b, or gathered by the AP 602-b, or both. For instance, the SR information response transmitted at 616 may include an indication of interference experienced by the AP 602-b from the AP 602-a (for example, 6 dB), collisions due to the BSS of the AP 602-a (for example, 15), a distance of the AP 602-a from the worst affected STA 604 (for example, 6 m), among other examples. At 618-, the AP 602-a may transmit a beacon. The beacon may not include the ML model for download by the STA 604-a, but may include one or more parameter values (for example, an upper threshold OBSS PD), which may be based on the SR information response received at 616. The STA 604-a may perform frame exchange at 620 (for example, may transmit one or more frames according to a SR based on the indicated parameters received at 618. The frames may be exchanged using an OBSS PD level, which may be selected by the STA 604-a to satisfy the SR parameters indicated at 618.

In some aspects, the AP 602-a may select the SR parameter according to the ML model. For example, the AP 602-a may identify one or more inputs based on the SR information response received at 616. For instance, the inputs may include local observations, such as a quantity of APs 602 and a quantity of RBO interruptions. The inputs may include information from associated STAs, such as an average quantity of APs identified by the associated STAs 604 (such as the information indicated in the SR information response at 608, 614, or both). The inputs may include information received from neighboring APs (such as the information indicated at 614, 616, or both). Such inputs may include an average quantity of collisions caused by the BSS corresponding to the AP 602-a, an upper threshold interference experienced due to the BSS corresponding to the AP 602-a, a distance to a worse affected BSS, among other examples. Such inputs may be input into the ML model by the AP 602-a, and the OBSS PD threshold may be the output of the ML model, which may be indicated at 618. In some aspects, the AP 602-a may indicate the information received at 616 and 608 to the STA 604-a (for example, the one or more inputs), and the STA 604-a may use the inputs to generate the SR parameters for transmitting the frame exchange according to the SR procedure.

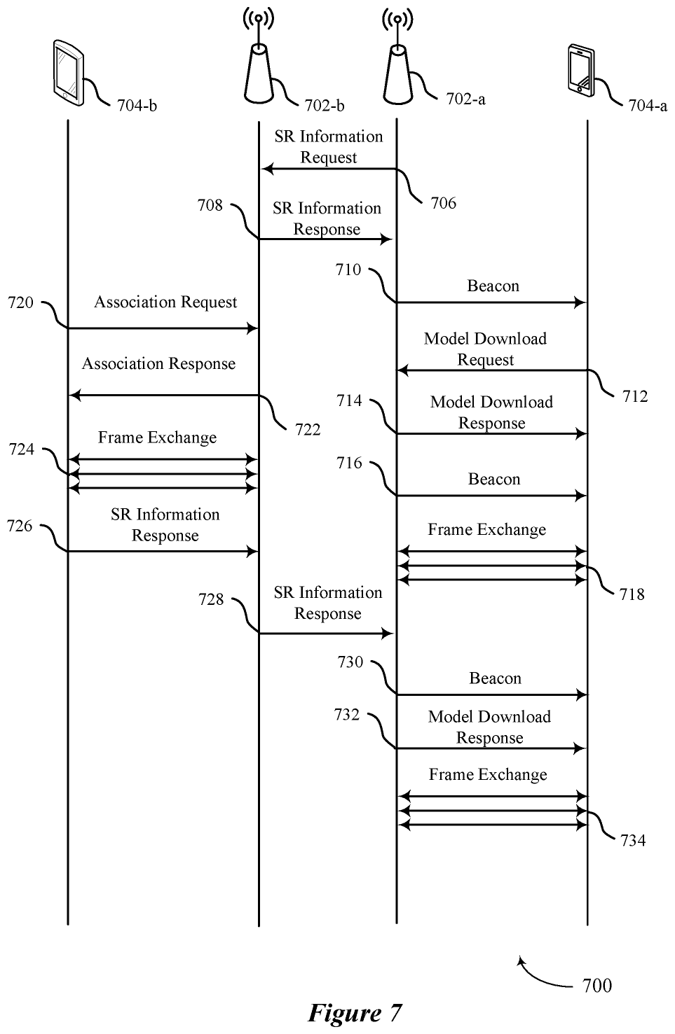

FIG. 7 shows an example of a process flow 700 that supports machine learning models for SR according to some aspects of the present disclosure. The process flow may include one or more devices, such as an AP 702-a, an AP 702-b, a STA 704-a, and a STA 704-b, which may each be examples of an AP 102 or a STA 104. The AP 702-a may collect information from neighboring APs 702-b, and may download ML models to associated STAs 704 (for example, the STA 704-a).

At 706, the AP 702-a may transmit an SR information request to the AP 702-b. The SR information request may indicate information for the AP 702-b to report, such as an interference experienced by the AP 702-b resulting from the BSS of the AP 702-a, and a distance from the AP 702-b to the AP 702-a, among other examples. At 708, the AP 702-b may transmit an SR information response, which may include the information requested at 706. For instance, the SR information response may include an indication of interference resulting from the BSS o the AP 702-a (such as 1 dB), and a distance to a worst affected STA 704 (for example, 21 m).

In some aspects, the AP 702-b also may provide information regarding one or more STAs 704 served by the AP 702 (for example, in a single SR information response or in a separate SR information response at 728). For instance, at 720, the STA 704-b may transmit an association request to the AP 702-b. At 722, the AP 702-b may transmit an association response to the STA 704-b. The STA 704-b may exchange frames with the AP 702-b at 724 based on the association response. At 726, the STA 704-b may transmit an SR information response autonomously, periodically, or in response to an SR information request from the AP 702-b. The SR information response may include a quantity of collisions due to the AP 702-a and the STA 704-a, among other examples.

At 710, the AP 702-a may transmit a message (for example, a beacon, a probe response frame, an operating mode notification frame, or another defined action frame) indicating that a new ML model is available. The new ML model may be based on the SR information response at 708. At 712, the STA 704-a may transmit a model downlink request, and at 714, the AP 702-a may transmit a model downlink response, indicating the ML model requested at 712. The model download response may include an indication of one or more inputs, the parameters for the ML model, an identifier for the ML model, one or more outputs for the ML model, or any combination thereof.

In some aspects at 716, the AP 702-a may transmit a message (for example, a beacon) including information regarding the ML model (for example, input information). The message may indicate a quantity of APs 702, an average interference to an OBSS, among other examples. Such information may be based on the SR information response at 708, or the SR information response at 728, or both. The STA 704-a may use the ML model to perform frame exchange at 718. For instance, the inputs may include information sent by the AP 702-a (such as a quantity of APs 702 identified by the AP 702-a or the AP 702-b, and an average interference to the OBSS), local observations (such as a quantity of APs 702-a detected by the STA 704-a, and a quantity of RBO interruptions), local measurements (such as an average throughput for a most recent burst, a median delay for a last threshold quantity of PPDUs, such as 100 PPDUs, a success rate of a most recent quantity of PPDUs, such as 100 PPDUs, among other examples), and an inference parameter (such as a candidate OBSS PD level). The ML model may output an estimated success probability, based on which the STA 704-a may determine whether to perform SR, or whether to perform SR according to an inference parameter, such as a candidate OBSS PD level.

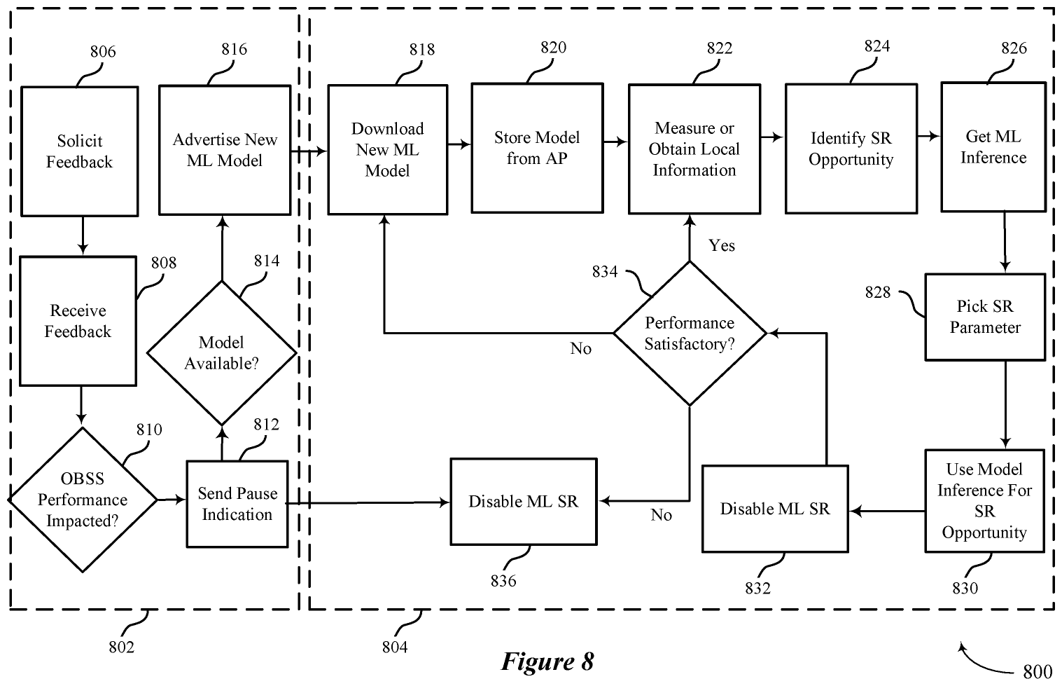

In some aspects, at 730, the AP 702-a may transmit a message (for example, a beacon, a probe response frame, an operating mode notification frame, or another defined action frame) disabling ML SR, or the ML model, or both. In some aspects, at 732, the AP 702-a may transmit a model download response. The model download response may be responsive to the model download request at 712, another model download request based on the message at 730, or autonomously based on having disabled ML SR. The model download response may indicate a new model. The STA 704-a may use the new ML model indicated at 732 to perform frame exchange with the AP 702-a according to a SR procedure at 734. The STA 704-a may use a new output based on the new ML model, such as a model-derived OBSS PD level. Such techniques are described in greater detail with reference to FIG. 8.

FIG. 8 shows an example of a flow diagram 800 that supports machine learning models for SR according to some aspects of the present disclosure. The flow diagram may be implemented by one or more devices, such as an AP 802 and a STA 804, which may each be an example of an AP 102 or a STA 104.

At 806, the AP 802 may solicit feedback (for example, from other APs 802 or from STAs 804 or both). At 808, the AP 802 may receive the requested feedback from neighboring APs 802. At 810, the AP 802 may determine whether OBSS performance is impacted. If the OBSS performance is impacted, the AP 802 may send a pause indication at 812 (for example, disabling a current ML model or ML SR). Otherwise, if the OBSS performance is not impacted, the AP 802 may continue to receive feedback at 808 and determine whether the OBSS performance is impacted at 810. At 836, the STA 804 may disable ML SR based on the pause indication. At 814, the AP 802 may determine whether a scenario-specific ML model is available. Such a determination may be based on the determination of whether the OBSS performance is impacted, based on the feedback. At 816, the AP 802 may advertise a new ML model based on the determination that the scenario-specific model is available.

At 818, the STA 804 may download the new ML model that was advertised at 816. At 820, the STA 804 may store the ML model received from the AP 802. At 822, the STA 804 may measure or obtain location information, which may be used as inputs for the ML model. At 824, the STA 804 may identify a SR opportunity (for example, such as a pending transmission of an inter-BSS PPDU). At 826, the STA 804 may determine an inference for the ML model for different SR parameters (such as OBSS PD values). At 828, the STA 804 may pick an SR parameter (such as an OBSS PD level) that improves the probability of successful transmission in the SR opportunities identified at 824. For example, based on the ML inferences for different OBSS PD values, the STA 804 may select a candidate OBSS PD value that is most likely to result in successful SR transmissions. At 830, the STA 804 may use a model inference for the SR opportunity. At 832 the STA 804 may measure model performance, and at 834 the STA 804 may determine whether performance is satisfactory based on the measurements. If performance is satisfactory (834—Yes), the STA 804 may measure or obtain local information for the currently used ML model. If performance is not satisfactory (834—No), then the STA 804 may disable the ML SR at 836 and download a new ML model at 818.

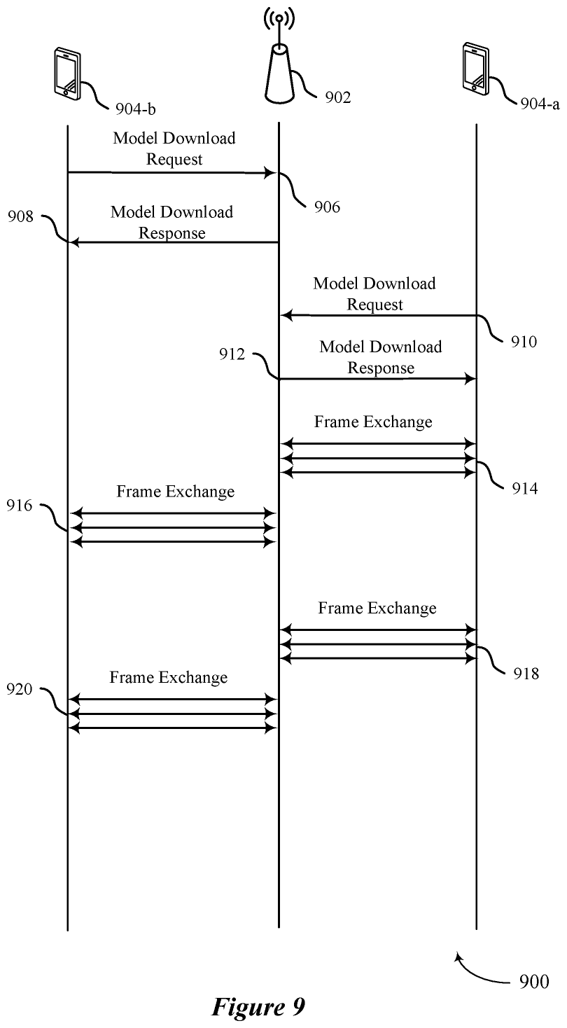

In some aspects, the STA 804 may be able to download various scenario specific models, as described in greater detail with reference to FIG. 9.

FIG. 9 shows an example of a process flow 900 that supports machine learning models for SR according to some aspects of the present disclosure. The process flow 900 may include one or more devices, including an AP 902, a STA 904-a, and a STA 904-b, which may each be examples of an AP 102 and a STA 104. As described herein, the AP 902 may download different models to STAs 904, or to the same STA 904 in different scenarios.

At 906, the STA 904-b may transmit a model download request. At 908, the AP 902 may transmit a model download response. The model download response may indicate one or more ML models (such as a first ML model and a second ML model for SR). Similarly, at 910, the STA 904-a may transmit a model download request. At 912, the AP 902 may transmit a model download response to the STA 904-a. The model download response may indicate one or more ML models (such as a third ML model and a fourth ML model for SR). The different ML models may be based on the model download request (such as ML models specified and requested by the STAs 904) or based on information reported by the STAs 904 or other APs 902. In some aspects, the different ML models may correspond to different service types (for example, voice (VO) services, video (VI) services, best effort (BE) services, or background (BK) services).

At 914, the STA 904-a may perform frame exchanges (for example, may transmit frames) to the AP 902. In some aspects, the STA 904-a may select a ML model indicated at 912 based on a corresponding service type. For instance, at 914 the STA 904-a may transmit VO frames according to an SR procedure based on the third ML model, and at 918 may transmit BE frames according to an SR procedure based on the fourth ML model. Similarly, at 916 the STA 904-a may transmit BE frames according to an SR procedure based on the first ML model, and at 920 may transmit VI frames according to an SR procedure based on the second ML model. In some aspects, the STAs 904 may autonomously select one of multiple candidate ML models based on a service type or other conditions. In some aspects, the AP 902 may indicate which ML model of a set of candidate ML models the STA 904 is to use.

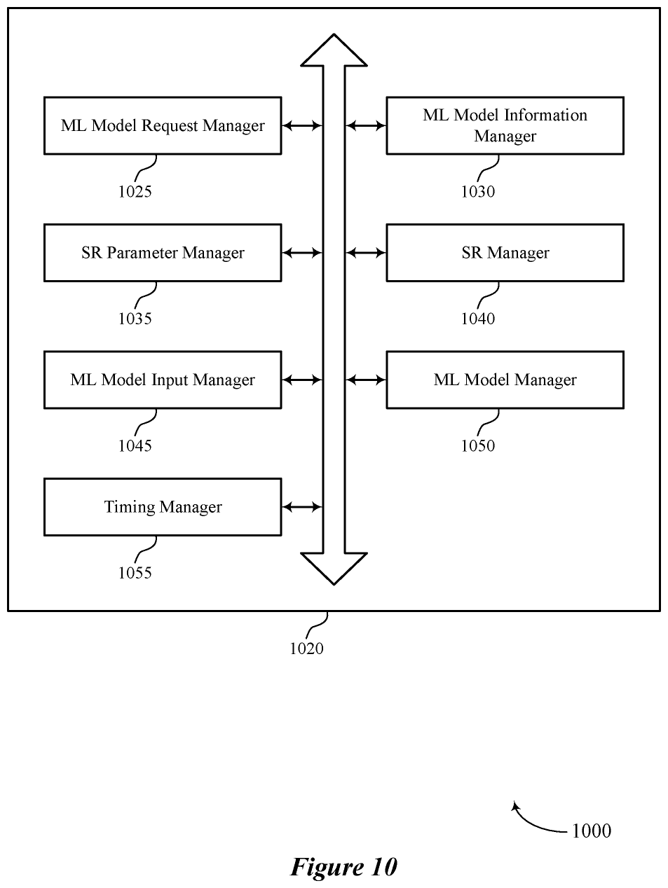

FIG. 10 shows a block diagram of an example wireless communication device 1000 that supports machine learning models for SR according to some aspects of the present disclosure. In various examples, the wireless communication device 1000 can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some aspects, the wireless communication device 1000 can be a device for use in a STA, such as STA 104 described with reference to FIG. 1. In some other examples, the wireless communication device 1000 can be a STA that includes such a chip, SoC, chipset, package or device as well as multiple antennas. The wireless communication device 1000 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some aspects, the wireless communication device 1000 also includes or can be coupled with an application processor which may be further coupled with another memory. In some aspects, the wireless communication device 1000 further includes a user interface (UI) (such as a touchscreen or keypad) and a display, which may be integrated with the UI to form a touchscreen display. In some aspects, the wireless communication device 1000 may further include one or more sensors such as, for example, one or more inertial sensors, accelerometers, temperature sensors, pressure sensors, or altitude sensors.

The wireless communication device 1000 includes an ML model request manager 1025, an ML model information manager 1030, an SR parameter manager 1035, an SR manager 1040, an ML model input manager 1045, an ML model manager 1050, and a timing manager 1055. Portions of the one or more of the ML model request manager 1025, the ML model information manager 1030, the SR parameter manager 1035, the SR manager 1040, the ML model input manager 1045, the ML model manager 1050, and the timing manager 1055 may be implemented at least in part in the hardware or firmware. For example, one or more of the ML model request manager 1025, the ML model information manager 1030, the SR parameter manager 1035, the SR manager 1040, the ML model input manager 1045, the ML model manager 1050, and the timing manager 1055 may be implemented at least in part by a modem. In some aspects, at least some of the ML model request manager 1025, the ML model information manager 1030, the SR parameter manager 1035, the SR manager 1040, the ML model input manager 1045, the ML model manager 1050, and the timing manager 1055 are implemented at least in part by a processor and as software stored in memory. For example, portions of one or more of the ML model request manager 1025, the ML model information manager 1030, the SR parameter manager 1035, the SR manager 1040, the ML model input manager 1045, the ML model manager 1050, and the timing manager 1055 can be implemented as non-transitory instructions (or “code”) executable by the processor to perform the functions or operations of the respective module.

In some aspects, the processor may be a component of a processing system. A processing system may generally refer to a system or series of machines or components that receives inputs and processes the inputs to produce a set of outputs (which may be passed to other systems or components of, for example, the device 1000). For example, a processing system of the device 1000 may refer to a system including the various other components or subcomponents of the device 1000, such as the processor, or a transceiver, or a communications manager, or other components or combinations of components of the device 1000. The processing system of the device 1000 may interface with other components of the device 1000, and may process information received from other components (such as inputs or signals) or output information to other components. For example, a chip or modem of the device 1000 may include a processing system, a first interface to output information and a second interface to obtain information. In some aspects, the first interface may refer to an interface between the processing system of the chip or modem and a transmitter, such that the device 1000 may transmit information output from the chip or modem. In some aspects, the second interface may refer to an interface between the processing system of the chip or modem and a receiver, such that the device 1000 may obtain information or signal inputs, and the information may be passed to the processing system. A person having ordinary skill in the art will readily recognize that the first interface also may obtain information or signal inputs, and the second interface also may output information or signal outputs.

The STA 1020 may support wireless communications at a device in accordance with examples as disclosed herein. The ML model request manager 1025 is capable of, configured to, or operable to support a means for outputting a first message requesting a machine learning model corresponding to a SR procedure. The ML model information manager 1030 is capable of, configured to, or operable to support a means for obtaining, in accordance with outputting the first message, a second message indicating information corresponding to the machine learning model, the information including a model structure corresponding to the machine learning model, an identifier indicating the machine learning model, one or more inputs corresponding to the machine learning model, one or more outputs corresponding to the machine learning model, or any combination thereof. The SR parameter manager 1035 is capable of, configured to, or operable to support a means for generating one or more SR parameter values corresponding to the one or more outputs according to the machine learning model and the one or more inputs. The SR manager 1040 is capable of, configured to, or operable to support a means for outputting one or more frames according to the SR procedure in accordance with the one or more SR parameter values.

In some aspects, the ML model input manager 1045 is capable of, configured to, or operable to support a means for obtaining, from one or more neighbor devices, one or more values corresponding to the one or more inputs. In some aspects, the ML model input manager 1045 is capable of, configured to, or operable to support a means for inputting the one or more values into the machine learning model, where generating the one or more SR parameter values is based on the inputting.

In some aspects, the ML model input manager 1045 is capable of, configured to, or operable to support a means for obtaining an indication of one or more values corresponding to the one or more inputs, the one or more values corresponding to one or more neighbor devices. In some aspects, the ML model input manager 1045 is capable of, configured to, or operable to support a means for inputting the one or more values into the machine learning model, where generating the one or more SR parameter values is based on the inputting.

In some aspects, the ML model input manager 1045 is capable of, configured to, or operable to support a means for inputting one or more local values corresponding to the one or inputs into the machine learning model, where generating the one or more SR parameter values is based on the inputting.

In some aspects, the ML model information manager 1030 is capable of, configured to, or operable to support a means for obtaining a third message indicating an availability of the machine learning model corresponding to the SR procedure, where outputting the first message is based on obtaining the third message.

In some aspects, the ML model manager 1050 is capable of, configured to, or operable to support a means for obtaining a third message including an instruction to disable the machine learning model. In some aspects, the ML model manager 1050 is capable of, configured to, or operable to support a means for disabling the machine learning model based on obtaining the third message. In some aspects, the ML model manager 1050 is capable of, configured to, or operable to support a means for outputting one or more additional frames according to a second SR procedure based on a set of SR parameters that is different than the one or more SR parameter values.

In some aspects, the timing manager 1055 is capable of, configured to, or operable to support a means for obtaining, from a second device, an indication of a time period during which the one or more outputs of the machine learning model are applicable to the SR procedure, where outputting the one or more frames occurs during the indicated time period.

In some aspects, the SR parameter manager 1035 is capable of, configured to, or operable to support a means for comparing the one or more SR parameter values with a set of SR parameter values that is different than the one or more SR parameter values. In some aspects, the SR parameter manager 1035 is capable of, configured to, or operable to support a means for selecting the one or more SR parameter values based on the comparing, where outputting the one or more frames is based on the selecting.

In some aspects, the SR parameter manager 1035 is capable of, configured to, or operable to support a means for obtaining an indication of one or more threshold parameter values, where outputting the one or more frames is based on the one or more SR parameter values satisfying the one or more threshold parameter values.

In some aspects, the ML model manager 1050 is capable of, configured to, or operable to support a means for obtaining control signaling that enables tuning of the machine learning model. In some aspects, the ML model manager 1050 is capable of, configured to, or operable to support a means for tuning one or more parameters of the machine learning model to generate an updated machine learning model according to local data generated by the device or obtained from one or more neighbor devices based on the control signaling that enables the tuning. In some aspects, the SR parameter manager 1035 is capable of, configured to, or operable to support a means for generating one or more additional SR parameter values corresponding to one or more outputs of the updated machine learning model.

In some aspects, the ML model manager 1050 is capable of, configured to, or operable to support a means for obtaining an indication of a second machine learning model corresponding to the SR procedure, a first set of conditions associated with the machine learning model, and a second set of conditions associated with the second machine learning model. In some aspects, the ML model manager 1050 is capable of, configured to, or operable to support a means for selecting, for the SR procedure, the machine learning model based on one or more current conditions satisfying the one or more conditions associated with the machine learning model, where the generating is based on the selecting.

In some aspects, the one or more inputs include one or more local observations, one or more obtained input values, one or more system inferences, or any combination thereof.

In some aspects, the one or more local observations include a quantity of STAs observed by the device satisfying a threshold signal strength, an average channel quality metric over a threshold time period, a distance to an AP, a distance to a threshold quantity of interfering outputting devices, an average interference level during a clear channel assessment, a success rate for previous transmissions at a candidate out of basic service set preamble detection level, a transmit power over a threshold time period, a quantity of interruptions during a threshold quantity of previous transmissions, or any combination thereof.

In some aspects, the one or more obtained input values include an observed interference power corresponding to a reference basic service set, a quantity of errors to STAs corresponding to the reference basic service set, a distance to a reference AP, a binary indication of whether a reference basic service set is generating interference, or any combination thereof.

In some aspects, the one or more system inferences include a candidate transmit power, a candidate PSR value, a candidate overlapping basic service set preamble detection threshold level, a candidate action to be taken by the device, or any combination thereof.

In some aspects, the one or more outputs include an overlapping basic service set preamble detection threshold level, a transmit power, a PSR value, an action to be taken by the device, an estimated performance metric corresponding to a candidate SR parameter value or a candidate transmit power value, or any combination thereof.

In some aspects, the machine learning model is configured to process the one or more inputs according to the SR procedure and output the one or more outputs.

Additionally, or alternatively, the STA 1020 may support wireless communications at a device in accordance with examples as disclosed herein. In some aspects, the ML model information manager 1030 is capable of, configured to, or operable to support a means for obtaining a first message including SR information corresponding to one or more inputs of a machine learning model associated with a SR procedure. The ML model input manager 1045 is capable of, configured to, or operable to support a means for inputting the one or more inputs into the machine learning model based on the SR information. In some aspects, the SR parameter manager 1035 is capable of, configured to, or operable to support a means for generating one or more SR parameter values corresponding to one or more outputs according to the machine learning model and the one or more inputs. In some aspects, the SR manager 1040 is capable of, configured to, or operable to support a means for outputting one or more frames according to the SR procedure in accordance with the one or more SR parameter values.

In some aspects, the ML model request manager 1025 is capable of, configured to, or operable to support a means for obtaining a SR information request message. In some aspects, the ML model information manager 1030 is capable of, configured to, or operable to support a means for outputting, based on obtaining the SR information request message, a SR information response message including one or more local observations, one or more local measurements, or a combination thereof, where obtaining the message including the SR information is based on outputting the SR information response message.

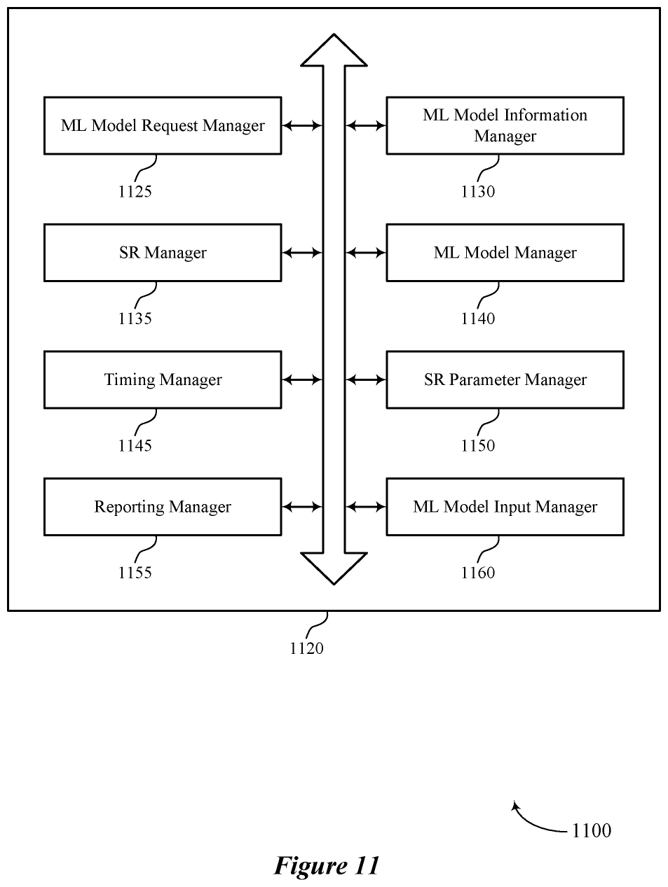

FIG. 11 shows a block diagram of an example wireless communication device 1100 that supports machine learning models for SR according to some aspects of the present disclosure. In various examples, the wireless communication device 1100 can be a chip, SoC, chipset, package or device that may include: one or more modems (such as, a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

In some aspects, the wireless communication device 1100 can be a device for use in an AP, such as AP 102 described with reference to FIG. 1. In some other examples, the wireless communication device 1100 can be an AP that includes such a chip, SoC, chipset, package or device as well as multiple antennas. The wireless communication device 1100 is capable of transmitting and receiving wireless communications in the form of, for example, wireless packets. For example, the wireless communication device can be configured or operable to transmit and receive packets in the form of physical layer PPDUs and MPDUs conforming to one or more of the IEEE 802.11 family of wireless communication protocol standards. In some aspects, the wireless communication device 1100 also includes or can be coupled with an application processor which may be further coupled with another memory. In some aspects, the wireless communication device 1100 further includes at least one external network interface that enables communication with a core network or backhaul network to gain access to external networks including the Internet.

The wireless communication device 1100 includes an ML model request manager 1125, an ML model information manager 1130, an SR manager 1135, an ML model manager 1140, a timing manager 1145, an SR parameter manager 1150, a reporting manager 1155, and an ML model input manager 1160. Portions of the one or more of the ML model request manager 1125, the ML model information manager 1130, the SR manager 1135, the ML model manager 1140, the timing manager 1145, the SR parameter manager 1150, the reporting manager 1155, and the ML model input manager 1160 may be implemented at least in part in the hardware or firmware. For example, one or more of the ML model request manager 1125, the ML model information manager 1130, the SR manager 1135, the ML model manager 1140, the timing manager 1145, the SR parameter manager 1150, the reporting manager 1155, and the ML model input manager 1160 may be implemented at least in part by a modem. In some aspects, at least some of the ML model request manager 1125, the ML model information manager 1130, the SR manager 1135, the ML model manager 1140, the timing manager 1145, the SR parameter manager 1150, the reporting manager 1155, and the ML model input manager 1160 are implemented at least in part by a processor and as software stored in memory. For example, portions of one or more of the ML model request manager 1125, the ML model information manager 1130, the SR manager 1135, the ML model manager 1140, the timing manager 1145, the SR parameter manager 1150, the reporting manager 1155, and the ML model input manager 1160 can be implemented as non-transitory instructions (or “code”) executable by the processor to perform the functions or operations of the respective module.

In some aspects, the processor may be a component of a processing system. A processing system may generally refer to a system or series of machines or components that receives inputs and processes the inputs to produce a set of outputs (which may be passed to other systems or components of, for example, the device 1100). For example, a processing system of the device 1100 may refer to a system including the various other components or subcomponents of the device 1100, such as the processor, or a transceiver, or a communications manager, or other components or combinations of components of the device 1100. The processing system of the device 1100 may interface with other components of the device 1100, and may process information received from other components (such as inputs or signals) or output information to other components. For example, a chip or modem of the device 1100 may include a processing system, a first interface to output information and a second interface to obtain information. In some aspects, the first interface may refer to an interface between the processing system of the chip or modem and a transmitter, such that the device 1100 may transmit information output from the chip or modem. In some aspects, the second interface may refer to an interface between the processing system of the chip or modem and a receiver, such that the device 1100 may obtain information or signal inputs, and the information may be passed to the processing system. A person having ordinary skill in the art will readily recognize that the first interface also may obtain information or signal inputs, and the second interface also may output information or signal outputs.

The AP 1120 may support wireless communications at in accordance with examples as disclosed herein. The ML model request manager 1125 is capable of, configured to, or operable to support a means for obtaining, from a first device by a second device, a first message requesting a machine learning model corresponding to a spatial reuse procedure. The ML model information manager 1130 is capable of, configured to, or operable to support a means for outputting, in accordance with obtaining the first message, a second message indicating information corresponding to the machine learning model, the information including a model structure corresponding to the machine learning model, an identifier indicating the machine learning model, one or more inputs corresponding to the machine learning model, one or more outputs corresponding to the machine learning model, or any combination thereof. The SR manager 1135 is capable of, configured to, or operable to support a means for obtaining one or more frames according to the spatial reuse procedure in accordance with one or more spatial reuse parameter values associated with the one or more outputs corresponding to the machine learning model.

In some aspects, the ML model information manager 1130 is capable of, configured to, or operable to support a means for outputting an indication of one or more values corresponding to the one or more inputs, the one or more values corresponding to one or more neighbor devices, where obtaining the one or more frames is based on outputting the indication of the one or more values.

In some aspects, the reporting manager 1155 is capable of, configured to, or operable to support a means for obtaining reporting information from the one or more neighbor devices. In some aspects, the ML model input manager 1160 is capable of, configured to, or operable to support a means for generating the one or more values corresponding to the one or more inputs based on the reporting information.

In some aspects, the ML model request manager 1125 is capable of, configured to, or operable to support a means for outputting an information request message to a third device indicating the one or more spatial reuse parameter values. In some aspects, the ML model information manager 1130 is capable of, configured to, or operable to support a means for obtaining, from the third device based on the information request message, an information response message including the one or more values corresponding to the one or more inputs.

In some aspects, the ML model manager 1140 is capable of, configured to, or operable to support a means for outputting a third message indicating an availability of the machine learning model corresponding to the spatial reuse procedure, where obtaining the request message is based on outputting the third message.

In some aspects, the ML model manager 1140 is capable of, configured to, or operable to support a means for outputting a third message including an instruction to disable the machine learning model. In some aspects, the SR manager 1135 is capable of, configured to, or operable to support a means for obtaining one or more additional frames according to a second spatial reuse procedure based on outputting the third message including the instruction to disable the machine learning model.

In some aspects, the timing manager 1145 is capable of, configured to, or operable to support a means for outputting an indication of a time period during which the one or more outputs of the machine learning model are applicable to the spatial reuse procedure, where obtaining the one or more frames according to the spatial reuse procedure occurs during the indicated time period.

In some aspects, the SR parameter manager 1150 is capable of, configured to, or operable to support a means for outputting an indication of one or more set of spatial reuse parameters that is different than the one or more spatial reuse parameter values, where obtaining the one or more frames is based on the one or more set of spatial reuse parameters.

In some aspects, the SR parameter manager 1150 is capable of, configured to, or operable to support a means for outputting an indication of one or more threshold parameter values, where obtaining the one or more frames is based on one or more spatial reuse parameter values corresponding to the machine learning model satisfying the one or more threshold parameter values.

In some aspects, the ML model manager 1140 is capable of, configured to, or operable to support a means for outputting control signaling that enables tuning of the machine learning model by a STA.

In some aspects, the ML model information manager 1130 is capable of, configured to, or operable to support a means for outputting an indication of a second machine learning model corresponding to the spatial reuse procedure, a first set of conditions associated with the machine learning model, and a second set of conditions associated with the second machine learning model.

In some aspects, the one or more inputs include one or more local observations, one or more obtained input values, one or more system inferences, or any combination thereof.

Additionally, or alternatively, the AP 1120 may support wireless communications at a device in accordance with examples as disclosed herein. In some aspects, the ML model information manager 1130 is capable of, configured to, or operable to support a means for outputting a message including spatial reuse information corresponding to one or more inputs of a machine learning model associated with a spatial reuse procedure. In some aspects, the SR manager 1135 is capable of, configured to, or operable to support a means for obtaining, from a first STA, one or more frames according to the spatial reuse procedure in accordance with one or more spatial reuse parameter values associated with the spatial reuse information.

In some aspects, the ML model request manager 1125 is capable of, configured to, or operable to support a means for outputting, to the first STA, a spatial reuse information request message. In some aspects, the ML model information manager 1130 is capable of, configured to, or operable to support a means for obtaining, based on outputting the spatial reuse information request message, a spatial reuse information response message including one or more local observations associated with the first STA, one or more local measurements associated with the first STA, or a combination thereof, where outputting the message including the spatial reuse information is based on obtaining the spatial reuse information response message.

In some aspects, the ML model information manager 1130 is capable of, configured to, or operable to support a means for outputting, to a second device, a spatial reuse information request message. In some aspects, the ML model information manager 1130 is capable of, configured to, or operable to support a means for obtaining, from the second device based on outputting the spatial reuse information request message, a spatial reuse information response message including one or more local observations associated with a set of multiple STAs associated with the second device, one or more local measurements associated with the set of multiple STAs associated with the second device, or a combination thereof, where outputting the message including the spatial reuse information is based on obtaining the spatial reuse information response message.

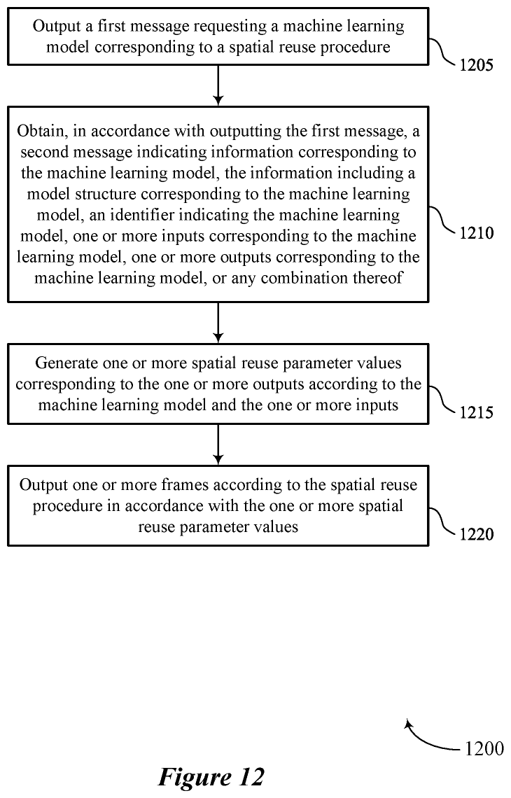

FIG. 12 shows a flowchart illustrating an example process 1200 performable at a wireless STA that supports machine learning models for spatial reuse according to some aspects of the present disclosure. The operations of the process 1200 may be an example of a method implemented by a wireless STA or its components as described herein. For example, the process 1200 may be performed by a wireless communication device, such as the wireless communication device 1000 described with reference to FIG. 10, operating as or within a wireless STA. In some aspects, the process 1200 may be performed by a wireless STA, such as one of the STAs 104 described with reference to FIG. 1.

In some aspects, in block 1205, the wireless STA may output a first message requesting a machine learning model corresponding to a spatial reuse procedure. The operations of block 1205 may be performed in accordance with examples as disclosed herein, such as at 306 of FIGS. 3 and/or 906 of FIG. 9 In some aspects, aspects of the operations of block 1205 may be performed by an ML model request manager 1025 as described with reference to FIG. 10.

In some aspects, in block 1210, the wireless STA may obtain, in accordance with outputting the first message, a second message indicating information corresponding to the machine learning model, the information including a model structure corresponding to the machine learning model, an identifier indicating the machine learning model, one or more inputs corresponding to the machine learning model, one or more outputs corresponding to the machine learning model, or any combination thereof. The operations of block 1210 may be performed in accordance with examples as disclosed herein, such as at 308 of FIGS. 3 and/or 908 of FIG. 9. In some aspects, aspects of the operations of block 1210 may be performed by an ML model information manager 1030 as described with reference to FIG. 10.

In some aspects, in block 1215, the wireless STA may generate one or more spatial reuse parameter values corresponding to the one or more outputs according to the machine learning model and the one or more inputs. The operations of block 1215 may be performed in accordance with examples as disclosed herein, such as outputs 506 of FIG. 5. In some aspects, aspects of the operations of block 1215 may be performed by an SR parameter manager 1035 as described with reference to FIG. 10.

In some aspects, in block 1220, the wireless STA may output one or more frames according to the spatial reuse procedure in accordance with the one or more spatial reuse parameter values. The operations of block 1220 may be performed in accordance with examples as disclosed herein, such as at 310 of FIG. 3 or such as at 620 of FIG. 6. In some aspects, aspects of the operations of block 1220 may be performed by an SR manager 1040 as described with reference to FIG. 10.

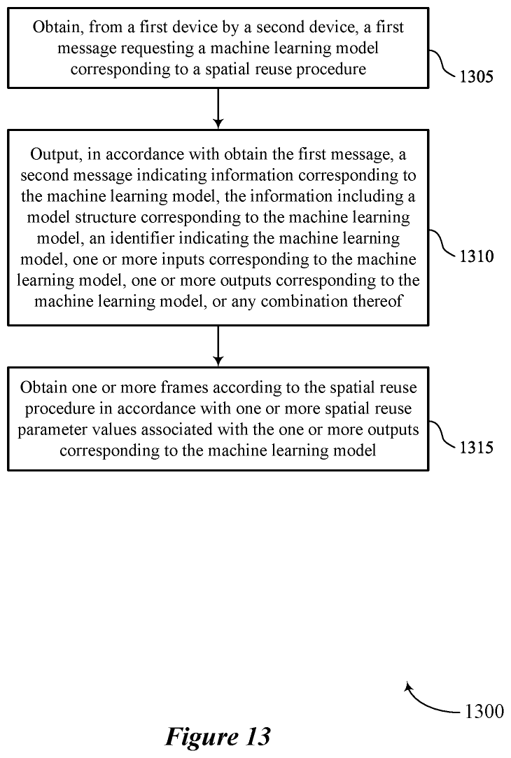

FIG. 13 shows a flowchart illustrating an example process 1300 performable at a wireless AP that supports machine learning models for spatial reuse according to some aspects of the present disclosure. The operations of the process 1300 may be an example of a method implemented by a wireless AP or its components as described herein. For example, the process 1300 may be performed by a wireless communication device, such as the wireless communication device 1100 described with reference to FIG. 11, operating as or within a wireless AP. In some aspects, the process 1300 may be performed by a wireless AP, such as one of the APs 102 described with reference to FIG. 1.

In some aspects, in block 1305, the wireless AP may obtain, from a first device by a second device, a first message requesting a machine learning model corresponding to a spatial reuse procedure. The operations of block 1305 may be performed in accordance with examples as disclosed herein, such as at 306 of FIGS. 3 and/or 906 of FIG. 9. In some aspects, aspects of the operations of block 1305 may be performed by an ML model request manager 1125 as described with reference to FIG. 11.

In some aspects, in block 1310, the wireless AP may output, in accordance with obtain the first message, a second message indicating information corresponding to the machine learning model, the information including a model structure corresponding to the machine learning model, an identifier indicating the machine learning model, one or more inputs corresponding to the machine learning model, one or more outputs corresponding to the machine learning model, or any combination thereof. The operations of block 1310 may be performed in accordance with examples as disclosed herein, such as at 308 of FIGS. 3 and/or 908 of FIG. 9. In some aspects, aspects of the operations of block 1310 may be performed by an ML model information manager 1130 as described with reference to FIG. 11.

In some aspects, in block 1315, the wireless AP may obtain one or more frames according to the spatial reuse procedure in accordance with one or more spatial reuse parameter values associated with the one or more outputs corresponding to the machine learning model. The operations of block 1315 may be performed in accordance with examples as disclosed herein, such as at 310 of FIG. 3 or 620 of FIG. 6. In some aspects, aspects of the operations of block 1315 may be performed by an SR manager 1135 as described with reference to FIG. 11.

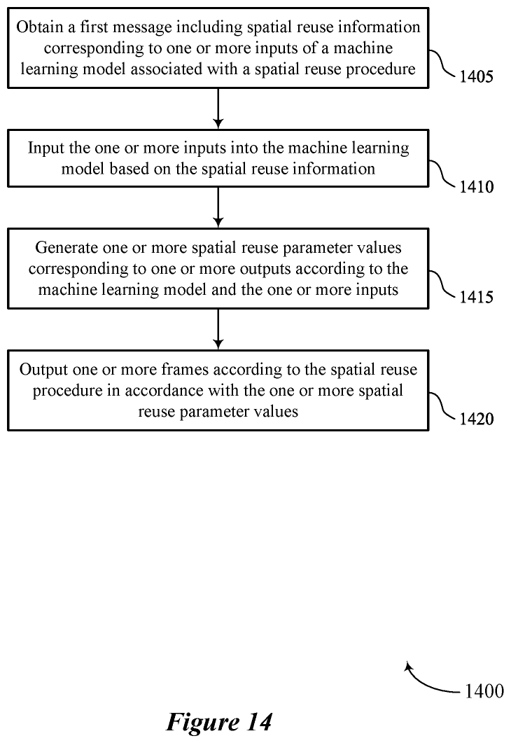

FIG. 14 shows a flowchart illustrating an example process 1400 performable at a wireless STA that supports machine learning models for spatial reuse according to some aspects of the present disclosure. The operations of the process 1400 may be an example of a method implemented by a wireless STA or its components as described herein. For example, the process 1400 may be performed by a wireless communication device, such as the wireless communication device 1000 described with reference to FIG. 10, operating as or within a wireless STA. In some aspects, the process 1400 may be performed by a wireless STA, such as one of the STAs 104 described with reference to FIG. 1.

In some aspects, in block 1405, the wireless STA may obtain a first message including spatial reuse information corresponding to one or more inputs of a machine learning model associated with a spatial reuse procedure. The operations of block 1405 may be performed in accordance with examples as disclosed herein, such as at 618 of FIG. 6. In some aspects, aspects of the operations of block 1405 may be performed by an ML model information manager 1030 as described with reference to FIG. 10.

In some aspects, in block 1410, the wireless STA may input the one or more inputs into the machine learning model based on the spatial reuse information. The operations of block 1410 may be performed in accordance with examples as disclosed herein, such as the inputs 502 of FIG. 5. In some aspects, aspects of the operations of block 1410 may be performed by an ML model input manager 1045 as described with reference to FIG. 10.

In some aspects, in block 1415, the wireless STA may generate one or more spatial reuse parameter values corresponding to one or more outputs according to the machine learning model and the one or more inputs. The operations of block 1415 may be performed in accordance with examples as disclosed herein, such as the outputs 506 of FIG. 5. In some aspects, aspects of the operations of block 1415 may be performed by an SR parameter manager 1035 as described with reference to FIG. 10.

In some aspects, in block 1420, the wireless STA may output one or more frames according to the spatial reuse procedure in accordance with the one or more spatial reuse parameter values. The operations of block 1420 may be performed in accordance with examples as disclosed herein, such as at 620 of FIG. 6. In some aspects, aspects of the operations of block 1420 may be performed by an SR manager 1040 as described with reference to FIG. 10.

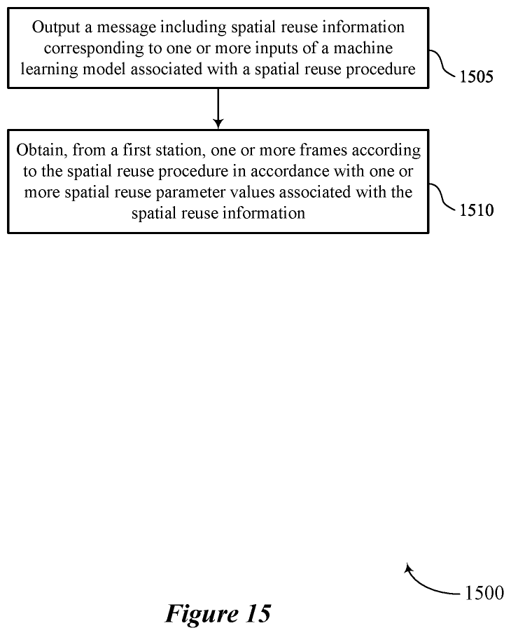

FIG. 15 shows a flowchart illustrating an example process 1500 performable at a wireless AP that supports machine learning models for spatial reuse according to some aspects of the present disclosure. The operations of the process 1500 may be an example of a method implemented by a wireless AP or its components as described herein. For example, the process 1500 may be performed by a wireless communication device, such as the wireless communication device 1100 described with reference to FIG. 11, operating as or within a wireless AP. In some aspects, the process 1500 may be performed by a wireless AP, such as one of the APs 102 described with reference to FIG. 1.

In some aspects, in block 1505, the wireless AP may output a message including spatial reuse information corresponding to one or more inputs of a machine learning model associated with a spatial reuse procedure. The operations of block 1505 may be performed in accordance with examples as disclosed herein, such as at 618 of FIG. 6. In some aspects, aspects of the operations of block 1505 may be performed by an ML model information manager 1130 as described with reference to FIG. 11.

In some aspects, in block 1510, the wireless AP may obtain, from a first STA, one or more frames according to the spatial reuse procedure in accordance with one or more spatial reuse parameter values associated with the spatial reuse information. The operations of block 1510 may be performed in accordance with examples as disclosed herein, such as at 620 of FIG. 6. In some aspects, aspects of the operations of block 1510 may be performed by an SR manager 1135 as described with reference to FIG. 11.

Aspect examples are described in the following numbered clauses:

The following provides an overview of aspects of the present disclosure:

Aspect 1: A method for wireless communications at a device, comprising: outputting a first message requesting a machine learning model corresponding to a spatial reuse procedure; obtaining, in accordance with outputting the first message, a second message indicating information corresponding to the machine learning model, the information comprising a model structure corresponding to the machine learning model, an identifier indicating the machine learning model, one or more inputs corresponding to the machine learning model, one or more outputs corresponding to the machine learning model, or any combination thereof; generating one or more spatial reuse parameter values corresponding to the one or more outputs according to the machine learning model and the one or more inputs; and outputting one or more frames according to the spatial reuse procedure in accordance with the one or more spatial reuse parameter values.

Aspect 2: The method of aspect 1, further comprising: obtaining, from one or more neighbor devices, one or more values corresponding to the one or more inputs; and inputting the one or more values into the machine learning model, wherein generating the one or more spatial reuse parameter values is based at least in part on the inputting.

Aspect 3: The method of any of aspects 1 through 2, further comprising: obtaining an indication of one or more values corresponding to the one or more inputs, the one or more values corresponding to one or more neighbor devices; and inputting the one or more values into the machine learning model, wherein generating the one or more spatial reuse parameter values is based at least in part on the inputting.

Aspect 4: The method of any of aspects 1 through 3, further comprising: inputting one or more local values corresponding to the one or inputs into the machine learning model, wherein generating the one or more spatial reuse parameter values is based at least in part on the inputting.

Aspect 5: The method of any of aspects 1 through 4, further comprising: obtaining a third message indicating an availability of the machine learning model corresponding to the spatial reuse procedure, wherein outputting the first message is based at least in part on obtaining the third message.

Aspect 6: The method of any of aspects 1 through 5, further comprising: obtaining a third message comprising an instruction to disable the machine learning model; disabling the machine learning model based at least in part on obtaining the third message; and outputting one or more additional frames according to a second spatial reuse procedure based at least in part on a set of spatial reuse parameters that is different than the one or more spatial reuse parameter values.

Aspect 7: The method of any of aspects 1 through 6, further comprising: obtaining, from a second device, an indication of a time period during which the one or more outputs of the machine learning model are applicable to the spatial reuse procedure, wherein outputting the one or more frames occurs during the indicated time period.

Aspect 8: The method of any of aspects 1 through 7, further comprising: comparing the one or more spatial reuse parameter values with a set of spatial reuse parameter values that is different than the one or more spatial reuse parameter values; and selecting the one or more spatial reuse parameter values based on the comparing, wherein outputting the one or more frames is based at least in part on the selecting.

Aspect 9: The method of any of aspects 1 through 8, further comprising: obtaining an indication of one or more threshold parameter values, wherein outputting the one or more frames is based at least in part on the one or more spatial reuse parameter values satisfying the one or more threshold parameter values.

Aspect 10: The method of any of aspects 1 through 9, further comprising: obtaining control signaling that enables tuning of the machine learning model; tuning one or more parameters of the machine learning model to generate an updated machine learning model according to local data generated by the device or obtained from one or more neighbor devices based at least in part on the control signaling that enables the tuning; and generating one or more additional spatial reuse parameter values corresponding to one or more outputs of the updated machine learning model.

Aspect 11: The method of any of aspects 1 through 10, further comprising: obtaining an indication of a second machine learning model corresponding to the spatial reuse procedure, a first set of conditions associated with the machine learning model, and a second set of conditions associated with the second machine learning model; and selecting, for the spatial reuse procedure, the machine learning model based at least in part on one or more current conditions satisfying the one or more conditions associated with the machine learning model, wherein the generating is based at least in part on the selecting.

Aspect 12: The method of any of aspects 1 through 11, wherein the one or more inputs comprise one or more local observations, one or more obtained input values, one or more system inferences, or any combination thereof.

Aspect 13: The method of aspect 12, wherein the one or more local observations comprise a quantity of stations observed by the device satisfying a threshold signal strength, an average channel quality metric over a threshold time period, a distance to an access point, a distance to a threshold quantity of interfering outputting devices, an average interference level during a clear channel assessment, a success rate for previous transmissions at a candidate out of basic service set preamble detection level, a transmit power over a threshold time period, a quantity of interruptions during a threshold quantity of previous transmissions, or any combination thereof.

Aspect 14: The method of any of aspects 12 through 13, wherein the one or more obtained input values comprise an observed interference power corresponding to a reference basic service set, a quantity of errors to stations corresponding to the reference basic service set, a distance to a reference access point, a binary indication of whether a reference basic service set is generating interference, or any combination thereof.

Aspect 15: The method of any of aspects 12 through 14, wherein the one or more system inferences comprise a candidate transmit power, a candidate parametrized spatial reuse value, a candidate overlapping basic service set preamble detection threshold level, a candidate action to be taken by the device, or any combination thereof.

Aspect 16: The method of any of aspects 1 through 15, wherein the one or more outputs comprise an overlapping basic service set preamble detection threshold level, a transmit power, a parametrized spatial reuse value, an action to be taken by the device, an estimated performance metric corresponding to a candidate spatial reuse parameter value or a candidate transmit power value, or any combination thereof.

Aspect 17: The method of any of aspects 1 through 16, wherein the machine learning model is configured to process the one or more inputs according to the spatial reuse procedure and output the one or more outputs.

Aspect 18: A method for wireless communications at, comprising: obtaining, from a first device by a second device, a first message requesting a machine learning model corresponding to a spatial reuse procedure; outputting, in accordance with obtaining the first message, a second message indicating information corresponding to the machine learning model, the information comprising a model structure corresponding to the machine learning model, an identifier indicating the machine learning model, one or more inputs corresponding to the machine learning model, one or more outputs corresponding to the machine learning model, or any combination thereof; and obtaining one or more frames according to the spatial reuse procedure in accordance with one or more spatial reuse parameter values associated with the one or more outputs corresponding to the machine learning model.

Aspect 19: The method of aspect 18, further comprising: outputting an indication of one or more values corresponding to the one or more inputs, the one or more values corresponding to one or more neighbor devices, wherein obtaining the one or more frames is based at least in part on outputting the indication of the one or more values.

Aspect 20: The method of aspect 19, further comprising: obtaining reporting information from the one or more neighbor devices; and generating the one or more values corresponding to the one or more inputs based at least in part on the reporting information.

Aspect 21: The method of any of aspects 19 through 20, further comprising: outputting an information request message to a third device indicating the one or more spatial reuse parameter values; and obtaining, from the third device based at least in part on the information request message, an information response message comprising the one or more values corresponding to the one or more inputs.

Aspect 22: The method of any of aspects 18 through 21, further comprising: outputting a third message indicating an availability of the machine learning model corresponding to the spatial reuse procedure, wherein obtaining the request message is based at least in part on outputting the third message.

Aspect 23: The method of any of aspects 18 through 22, further comprising: outputting a third message comprising an instruction to disable the machine learning model; and obtaining one or more additional frames according to a second spatial reuse procedure based at least in part on outputting the third message comprising the instruction to disable the machine learning model.

Aspect 24: The method of any of aspects 18 through 23, further comprising: outputting an indication of a time period during which the one or more outputs of the machine learning model are applicable to the spatial reuse procedure, wherein obtaining the one or more frames according to the spatial reuse procedure occurs during the indicated time period.

Aspect 25: The method of any of aspects 18 through 24, further comprising: outputting an indication of one or more set of spatial reuse parameters that is different than the one or more spatial reuse parameter values, wherein obtaining the one or more frames is based at least in part on the one or more set of spatial reuse parameters.

Aspect 26: The method of any of aspects 18 through 25, further comprising: outputting an indication of one or more threshold parameter values, wherein obtaining the one or more frames is based at least in part on one or more spatial reuse parameter values corresponding to the machine learning model satisfying the one or more threshold parameter values.

Aspect 27: The method of any of aspects 18 through 26, further comprising: outputting control signaling that enables tuning of the machine learning model by a station.

Aspect 28: The method of any of aspects 18 through 27, further comprising: outputting an indication of a second machine learning model corresponding to the spatial reuse procedure, a first set of conditions associated with the machine learning model, and a second set of conditions associated with the second machine learning model.

Aspect 29: The method of any of aspects 18 through 28, wherein the one or more inputs comprise one or more local observations, one or more obtained input values, one or more system inferences, or any combination thereof.

Aspect 30: A method for wireless communications at a device, comprising: obtaining a first message comprising spatial reuse information corresponding to one or more inputs of a machine learning model associated with a spatial reuse procedure; inputting the one or more inputs into the machine learning model based at least in part on the spatial reuse information; generating one or more spatial reuse parameter values corresponding to one or more outputs according to the machine learning model and the one or more inputs; and outputting one or more frames according to the spatial reuse procedure in accordance with the one or more spatial reuse parameter values.

Aspect 31: The method of aspect 30, further comprising: obtaining a spatial reuse information request message; and outputting, based at least in part on obtaining the spatial reuse information request message, a spatial reuse information response message comprising one or more local observations, one or more local measurements, or a combination thereof, wherein obtaining the message comprising the spatial reuse information is based at least in part on outputting the spatial reuse information response message.

Aspect 32: A method for wireless communications at a device, comprising: outputting a message comprising spatial reuse information corresponding to one or more inputs of a machine learning model associated with a spatial reuse procedure; and obtaining, from a first station, one or more frames according to the spatial reuse procedure in accordance with one or more spatial reuse parameter values associated with the spatial reuse information.

Aspect 33: The method of aspect 32, further comprising: outputting, to the first station, a spatial reuse information request message; and obtaining, based at least in part on outputting the spatial reuse information request message, a spatial reuse information response message comprising one or more local observations associated with the first station, one or more local measurements associated with the first station, or a combination thereof, wherein outputting the message comprising the spatial reuse information is based at least in part on obtaining the spatial reuse information response message.

Aspect 34: The method of any of aspects 32 through 33, further comprising: outputting, to a second device, a spatial reuse information request message; and obtaining, from the second device based at least in part on outputting the spatial reuse information request message, a spatial reuse information response message comprising one or more local observations associated with a plurality of stations associated with the second device, one or more local measurements associated with the plurality of stations associated with the second device, or a combination thereof, wherein outputting the message comprising the spatial reuse information is based at least in part on obtaining the spatial reuse information response message.

Aspect 35: An apparatus for wireless communications at a device, comprising at least one memory, and at least one processor communicatively coupled with the at least one memory, the at least one processor operable to cause the apparatus to perform a method of any of aspects 1 through 17.

Aspect 36: An apparatus for wireless communications at a device, comprising at least one means for performing a method of any of aspects 1 through 17.

Aspect 37: A non-transitory computer-readable medium storing code for wireless communications at a device, the code comprising instructions executable by a processor to perform a method of any of aspects 1 through 17.

Aspect 38: An apparatus for wireless communications at, comprising a processor; memory coupled with the processor; and instructions stored in the memory and executable by the processor to cause the apparatus to perform a method of any of aspects 18 through 29.

Aspect 39: An apparatus for wireless communications at, comprising at least one means for performing a method of any of aspects 18 through 29.

Aspect 40: A non-transitory computer-readable medium storing code for wireless communications at, the code comprising instructions executable by a processor to perform a method of any of aspects 18 through 29.

Aspect 41: An apparatus for wireless communications at a device, comprising a processor; memory coupled with the processor; and instructions stored in the memory and executable by the processor to cause the apparatus to perform a method of any of aspects 30 through 31.

Aspect 42: An apparatus for wireless communications at a device, comprising at least one means for performing a method of any of aspects 30 through 31.

Aspect 43: A non-transitory computer-readable medium storing code for wireless communications at a device, the code comprising instructions executable by a processor to perform a method of any of aspects 30 through 31.

Aspect 44: An apparatus for wireless communications at a device, comprising a processor; memory coupled with the processor; and instructions stored in the memory and executable by the processor to cause the apparatus to perform a method of any of aspects 32 through 34.

Aspect 45: An apparatus for wireless communications at a device, comprising at least one means for performing a method of any of aspects 32 through 34.

Aspect 46: A non-transitory computer-readable medium storing code for wireless communications at a device, the code comprising instructions executable by a processor to perform a method of any of aspects 32 through 34.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,”’ or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single aspect. Conversely, various features that are described in the context of a single aspect also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communications at a device, comprising:
at least one memory; and
at least one processor communicatively coupled with the at least one memory, the at least one processor operable to cause the device to:
output a first message requesting a machine learning model corresponding to a spatial reuse procedure;
obtain, in accordance with outputting the first message, a second message indicating information corresponding to the machine learning model, the information comprising a model structure corresponding to the machine learning model, an identifier indicating the machine learning model, one or more inputs corresponding to the machine learning model, one or more outputs corresponding to the machine learning model, or any combination thereof;
generate one or more spatial reuse parameter values corresponding to the one or more outputs according to the machine learning model and the one or more inputs; and
output one or more frames according to the spatial reuse procedure in accordance with the one or more spatial reuse parameter values.

2. The apparatus of claim 1, wherein the at least one processor is further operable to cause the device to:
obtain, from one or more neighbor devices, one or more values corresponding to the one or more inputs; and
input the one or more values into the machine learning model, wherein generating the one or more spatial reuse parameter values is based at least in part on the inputting.

3. The apparatus of claim 1, wherein the at least one processor is further operable to cause the device to:
obtain an indication of one or more values corresponding to the one or more inputs, the one or more values corresponding to one or more neighbor devices; and
input the one or more values into the machine learning model, wherein generating the one or more spatial reuse parameter values is based at least in part on the inputting.

4. The apparatus of claim 1, wherein the at least one processor is further operable to cause the device to:
input one or more local values corresponding to the one or inputs into the machine learning model, wherein generating the one or more spatial reuse parameter values is based at least in part on the inputting.

5. The apparatus of claim 1, wherein the at least one processor is further operable to cause the device to:
obtain a third message indicating an availability of the machine learning model corresponding to the spatial reuse procedure, wherein outputting the first message is based at least in part on obtaining the third message.

6. The apparatus of claim 1, wherein the at least one processor is further operable to cause the device to:
obtain a third message comprising an instruction to disable the machine learning model;
disable the machine learning model based at least in part on obtaining the third message; and
output one or more additional frames according to a second spatial reuse procedure based at least in part on a set of spatial reuse parameters that is different than the one or more spatial reuse parameter values.

7. The apparatus of claim 1, wherein the at least one processor is further operable to cause the device to:
obtain, from a second device, an indication of a time period during which the one or more outputs of the machine learning model are applicable to the spatial reuse procedure, wherein outputting the one or more frames occurs during the indicated time period.

8. The apparatus of claim 1, wherein the at least one processor is further operable to cause the device to:
compare the one or more spatial reuse parameter values with a set of spatial reuse parameter values that is different than the one or more spatial reuse parameter values; and
select the one or more spatial reuse parameter values based on the comparing, wherein outputting the one or more frames is based at least in part on the selecting.

9. The apparatus of claim 1, wherein the at least one processor is further operable to cause the device to:
obtain an indication of one or more threshold parameter values, wherein outputting the one or more frames is based at least in part on the one or more spatial reuse parameter values satisfying the one or more threshold parameter values.

10. The apparatus of claim 1, wherein the at least one processor is further operable to cause the device to:
obtain control signaling that enables tuning of the machine learning model;
tune one or more parameters of the machine learning model to generate an updated machine learning model according to local data generated by the device or obtained from one or more neighbor devices based at least in part on the control signaling that enables the tuning; and
generate one or more additional spatial reuse parameter values corresponding to one or more outputs of the updated machine learning model.

11. The apparatus of claim 1, wherein the at least one processor is further operable to cause the device to:
obtain an indication of a second machine learning model corresponding to the spatial reuse procedure, a first set of conditions associated with the machine learning model, and a second set of conditions associated with the second machine learning model; and
select, for the spatial reuse procedure, the machine learning model based at least in part on one or more current conditions satisfying the one or more conditions associated with the machine learning model, wherein the generating is based at least in part on the selecting.

12. The apparatus of claim 1, wherein the one or more inputs comprise one or more local observations, one or more obtained input values, one or more system inferences, or any combination thereof.

13. The apparatus of claim 12, wherein the one or more local observations comprise a quantity of stations observed by the device satisfying a threshold signal strength, an average channel quality metric over a threshold time period, a distance to an access point, a distance to a threshold quantity of interfering outputting devices, an average interference level during a clear channel assessment, a success rate for previous transmissions at a candidate out of basic service set preamble detection level, a transmit power over a threshold time period, a quantity of interruptions during a threshold quantity of previous transmissions, or any combination thereof.

14. The apparatus of claim 12, wherein the one or more obtained input values comprise an observed interference power corresponding to a reference basic service set, a quantity of errors to stations corresponding to the reference basic service set, a distance to a reference access point, a binary indication of whether a reference basic service set is generating interference, or any combination thereof.

15. The apparatus of claim 12, wherein the one or more system inferences comprise a candidate transmit power, a candidate parametrized spatial reuse value, a candidate overlapping basic service set preamble detection threshold level, a candidate action to be taken by the device, or any combination thereof.

16. The apparatus of claim 1, wherein the one or more outputs comprise an overlapping basic service set preamble detection threshold level, a transmit power, a parametrized spatial reuse value, an action to be taken by the device, an estimated performance metric corresponding to a candidate spatial reuse parameter value or a candidate transmit power value, or any combination thereof.

17. The apparatus of claim 1, wherein the machine learning model is configured to process the one or more inputs according to the spatial reuse procedure and output the one or more outputs.

18. An apparatus for wireless communications at a device, comprising:
at least one memory; and
at least one processor communicatively coupled with the at least one memory, the at least one processor operable to cause the device to:
obtain a first message requesting a machine learning model corresponding to a spatial reuse procedure;
output, in accordance with obtain the first message, a second message indicating information corresponding to the machine learning model, the information comprising a model structure corresponding to the machine learning model, an identifier indicating the machine learning model, one or more inputs corresponding to the machine learning model, one or more outputs corresponding to the machine learning model, or any combination thereof; and
obtain one or more frames according to the spatial reuse procedure in accordance with one or more spatial reuse parameter values associated with the one or more outputs corresponding to the machine learning model.

19. The apparatus of claim 18, wherein the at least one processor is further operable to cause the device to:
output an indication of one or more values corresponding to the one or more inputs, the one or more values corresponding to one or more neighbor devices, wherein obtaining the one or more frames is based at least in part on outputting the indication of the one or more values.

20. The apparatus of claim 19, wherein the at least one processor is further operable to cause the device to:
obtain reporting information from the one or more neighbor devices; and
generate the one or more values corresponding to the one or more inputs based at least in part on the reporting information.

21. The apparatus of claim 19, wherein the at least one processor is further operable to cause the device to:
output an information request message to a third device indicating the one or more spatial reuse parameter values; and
obtain, from the third device based at least in part on the information request message, an information response message comprising the one or more values corresponding to the one or more inputs.

22. The apparatus of claim 18, wherein the at least one processor is further operable to cause the device to:
output a third message indicating an availability of the machine learning model corresponding to the spatial reuse procedure, wherein obtaining the request message is based at least in part on outputting the third message.

23. The apparatus of claim 18, wherein the at least one processor is further operable to cause the device to:
output a third message comprising an instruction to disable the machine learning model; and
obtain one or more additional frames according to a second spatial reuse procedure based at least in part on outputting the third message comprising the instruction to disable the machine learning model.

24. The apparatus of claim 18, wherein the at least one processor is further operable to cause the device to:
output an indication of a time period during which the one or more outputs of the machine learning model are applicable to the spatial reuse procedure, wherein obtaining the one or more frames according to the spatial reuse procedure occurs during the indicated time period.

25. The apparatus of claim 18, wherein the at least one processor is further operable to cause the device to:
output an indication of one or more set of spatial reuse parameters that is different than the one or more spatial reuse parameter values, wherein obtaining the one or more frames is based at least in part on the one or more set of spatial reuse parameters.

26. The apparatus of claim 18, wherein the at least one processor is further operable to cause the device to:
output an indication of one or more threshold parameter values, wherein obtaining the one or more frames is based at least in part on one or more spatial reuse parameter values corresponding to the machine learning model satisfying the one or more threshold parameter values.

27. The apparatus of claim 18, wherein the at least one processor is further operable to cause the device to:
output control signal that enables tuning of the machine learning model by a station.

28. The apparatus of claim 18, wherein the at least one processor is further operable to cause the device to:
output an indication of a second machine learning model corresponding to the spatial reuse procedure, a first set of conditions associated with the machine learning model, and a second set of conditions associated with the second machine learning model.

29. The apparatus of claim 18, wherein the one or more inputs comprise one or more local observations, one or more obtained input values, one or more system inferences, or any combination thereof.

30. An apparatus for wireless communications at a device, comprising:
at least one memory; and
at least one processor communicatively coupled with the at least one memory, the at least one processor operable to cause the device to:
obtain a first message comprising spatial reuse information corresponding to one or more inputs of a machine learning model associated with a spatial reuse procedure;
input the one or more inputs into the machine learning model based at least in part on the spatial reuse information;
generate one or more spatial reuse parameter values corresponding to one or more outputs according to the machine learning model and the one or more inputs; and
output one or more frames according to the spatial reuse procedure in accordance with the one or more spatial reuse parameter values.

31. The apparatus of claim 30, wherein the at least one processor is further operable to cause the device to:
obtain a spatial reuse information request message; and
output, base at least in part on obtaining the spatial reuse information request message, a spatial reuse information response message comprising one or more local observations, one or more local measurements, or a combination thereof, wherein obtaining the message comprising the spatial reuse information is based at least in part on outputting the spatial reuse information response message.

32. An apparatus for wireless communications at a device, comprising:
at least one memory; and
at least one processor communicatively coupled with the at least one memory, the at least one processor operable to cause the device to:
output a message comprising spatial reuse information corresponding to one or more inputs of a machine learning model associated with a spatial reuse procedure; and
obtain, from a first station, one or more frames according to the spatial reuse procedure in accordance with one or more spatial reuse parameter values associated with the spatial reuse information.

33. The apparatus of claim 32, wherein the at least one processor is further operable to cause the device to:
output, to the first station, a spatial reuse information request message; and
obtain, base at least in part on outputting the spatial reuse information request message, a spatial reuse information response message comprising one or more local observations associated with the first station, one or more local measurements associated with the first station, or a combination thereof, wherein outputting the message comprising the spatial reuse information is based at least in part on obtaining the spatial reuse information response message.

34. The apparatus of claim 32, wherein the at least one processor is further operable to cause the device to:
output, to a second device, a spatial reuse information request message; and
obtain, from the second device based at least in part on outputting the spatial reuse information request message, a spatial reuse information response message comprising one or more local observations associated with a plurality of stations associated with the second device, one or more local measurements associated with the plurality of stations associated with the second device, or a combination thereof, wherein outputting the message comprising the spatial reuse information is based at least in part on obtaining the spatial reuse information response message.
